(19) United States
(12) Patent Application Publication
(10) Pub. No.: US 2011/0208703 A1
(43) Pub. Date: Aug. 25, 2011

(54) SELECTIVITY ESTIMATION

(76) Inventors: Damien Fisher, London (GB); Sebastian Maneth, South Wales (AU)

(21) Appl. No.: 12/301,968

(22) PCT Filed: May 24, 2007
(86) PCT No.: PCT/AU2007/000723

§ 371 Date: May 12, 2011

(30) Foreign Application Priority Data
May 24, 2006 (AU) 2006902814
Sep. 11, 2006 (AU) 2006905012

(51) Int. Cl. G06F 17/30; G06F 7/00

(52) U.S. Cl. 707/692; 707/718; 707/693; 707/E17.017; 707/E17.044; 707/E17.005

(57) ABSTRACT

The invention concerns the compression, querying and updating of tree structured data. For example, but not limited to, the invention concerns a synopsis (16) of a database system that is used in the selection of the optimal execution plan (10) for a query (8). Compression is based on representing the data as a set of definition and compressing the data by consolidating the number of definitions. A selectivity estimate can be determined based on this compressed representation, including a maximum and minimum selectivity count. The invention also provides a way to update the compressed version of the tree data without uncompressing large amounts of the compressed data unnecessarily. Aspects of the invention are methods, computer systems and software for performing the invention.

### TECHNICAL FIELD

The invention concerns the compression and querying of tree structured data. For example, but not limited to, the invention concerns a synopsis of a database system that is used in the selection of the optimal execution plan for a query. The invention concerns the methods, computer systems and software for generating a compressed representation of tree structured data, storing and updating the compressed representation, and selectivity estimation of a query on the tree structured data and compressed representation.

### BACKGROUND ART

The Extensible Markup Language (XML) has found practical application in numerous domains, including data interchange, streaming data, and data storage. The semi-structured nature of XML allows data to be represented in a considerably more flexible nature than in the traditional relational paradigm. However, the tree-based data model underlying XML poses many challenges to efficient query evaluation.

Estimating the selectivity of queries is a crucial problem in database systems. Virtually all database systems rely on the use of selectivity estimates to choose amongst the many possible execution plans for a particular query. In terms of XML databases, the problem of selectivity estimation of queries presents new challenges: many evaluation operators are possible, such as simple navigation, structural joins, or twig joins, and many different indexes are possible ranging from traditional B-trees to complicated XML-specific graph indexes.

Selectivity estimation is the problem of estimating the number of hits of a given query without traversing the underlying database. This problem is central to any database system because all modern approaches to query evaluation heavily depend upon the ability to estimate query selectivity. In fact, the execution time of a query can vary from seconds to hours depending upon the quality of the selectivity estimator. In the conventional (relational) setting, this problem has been well studied and powerful techniques are already available. However, in the new setting of semistructured data (such as XML) the problem presents many new challenges.

The most important aspect of a selectivity estimator is the use of only very little space internally, so that it fits into main memory. If the estimator uses too much space and thus needs to be stored on the hard drive, then it may be just as fast to evaluate the query as it would be to estimate its selectivity.

FIG. 1 demonstrates how queries are evaluated in modern computersied database systems. A user's query 8 is transformed by the query planner 10 into a physical query plan 12, which is a low-level recipe for answering the query. The query planner 10 uses the selectivity estimator 14 which relies on a small, in memory, structure called the synopsis 16 to choose the best plan amongst the many possible physical query plans. The physical query plan 12 is then executed on the actual database 18, possibly using various supporting indexes 20, and constructs the result 22 which is then returned to the user.

An important component of any XML database system is effective selectivity estimation: given a query Q over a database D, what is the approximate result size of Q over D? This problem arises in several domains. Firstly, a rough estimate of the result size of a query can indicate to the user whether or not a query is appropriately framed before running a potentially expensive query. Selectivity estimation also has natural applications to approximate query answering. However, the most significant application of selectivity estimation is in query plan selection.

For example, suppose we have the sets A, B, and C of all a, b, and c elements in a document, and we wish to evaluate the query//a[.//b]//c. We could do this by performing a structural join on A and B, and joining this result with C. Alternatively, we could first join A and C, and then join the intermediate result with B. The relative speed of these two queries is highly dependent on the selectivity of the initial structural joins. While for these kinds of queries a twig join is more appropriate, similar issues arise involving the relative result sizes for two or more twig queries, particularly in more sophisticated query languages such as XQuery.

In another example of why selectivity estimation is important, consider the problem of querying all objects in a database matching both “football” and “Paraguay”. There are two possible ways of evaluating this query. The first approach is to get all objects matching “football”, and then check each of these to see if it also matches “Paraguay”. Another approach is to start with all “Paraguay” objects and then find the ones matching “football”. If there are 10,000,000 “football” objects in the database, but only 5 “Paraguay” objects, then the second approach will be much faster, as it only scans 5 objects, while the first approach scans 10,000,000 objects. Thus, when the database has to decide in which order to evaluate a query, the ability to estimate the selectivity of queries can have a tremendous impact on the query evaluation time.

Thus, in any database system, being able to accurately estimate the result size of the sub-expressions in a query is of great practical importance. All previous work on the problem of selectivity estimation suffers for XML data from some combination of the following problems:

expensive construction—a problem with many techniques is that synopsis construction is extremely expensive. Any algorithm which requires more than one pass of the database is likely to be too expensive to run on very large databases.

non-updateability—almost every selectivity estimation technique to date fails to handle updates to the underlying database. As they are static, their accuracy deteriorates as the database changes. The only realistic solution is to periodically rebuild them from scratch, which is obviously expensive.

limited utility—selectivity estimation techniques generally consider only a limited subset of a query language. Most previous XML techniques consider extremely limited languages, such as simple path expressions. For example, no previous XML selectivity estimation technique can handle the order-sensitive axes of XPath, such as following.

no guarantee on accuracy—all existing techniques use heuristics to generate their selectivity estimates. These heuristics, while based on well-justified assumptions in many cases, do not provide any guarantee of accuracy, and hence the computed estimate can be wildly inaccurate.

### SUMMARY OF THE INVENTION

In a first aspect the invention provides a method of generating a compressed representation of tree structured data, the method comprising the steps of:

(a) compressing the tree structured data by converting the ranked tree to a set of definitions that can each refer to other definitions of the set and/or a terminal definition that does not refer to any definition;

(b) determining the number of times each definition is referenced in other definitions; and

(c) compressing the set of definitions by deleting the definition that is referred in other definitions substantially the least, and replacing all references to the deleted definition with an indication that the definition has been deleted.

The method may comprise repeating step (c) until the tree structured data is suitably compressed. The tree structured data may be suitably compressed when a predetermined number of definitions have been deleted, the set of definitions is a predetermined size or each of the definitions in the set do not refer to any other definition.

The compressed representation of the tree structured data may be used for determining the selectivity of a query to be performed on the tree structured data, such as a synopsis. The selectivity of a query may be used to determine an execution plan for the query on the tree structured data, or for approximate query answering.

Step (c) may include identifying repetitions of subtrees and/or tree patterns consisting of at least two nodes and replacing them with a reference to a definition and creating a new definition defining the identified subtree or tree pattern. A definition may include input parameters.

The indication that the definition has been deleted may comprise a predefined character or symbol, such as ‘*’. The indication that the definition has been deleted may also comprise statistical information of the deleted definition, such as the size and height values of the subtree or tree pattern that the deleted definition defined.

The set of definitions may comprise an ordered set of definitions having at one end a definition that does not refer to any other definition and at the other end a start definition. Each definition may have an identifier and may be referenced in other definitions using this identifier. Each definition in the ordered set of definitions may refer to only preceding definitions or only antecedent definitions in the ordered set of definitions.

The method may further comprise the initial step of converting the tree structured data to a ranked tree, and step (a) is performed on the ranked tree. The ranked tree may be a binary ranked tree where each left edge of the binary tree represents the “first child” relationship of the tree structured data and the right edge represents the “next sibling” relationship of the tree structured data.

The compressed representation of the tree may be lossy compression.

The method may further comprise the step of storing the compressed representation of the tree structured data, the method comprising the steps of:
(a) packed bit coding each definition; and
(b) storing a concatenation of each packed bit encoded definition.

The method of storing the compressed representation may further comprise 30 creating a lookup table for all unique combinations of size and height values of definitions that have been deleted and replacing all size and height values in the compressed representation with a look-up value from the look-up table corresponding to the correct size and height value combination.

The compressed representation of the tree structured data (i.e., synopsis) of the invention can be constructed in a single pass of the tree structured data.

In yet another aspect, the invention comprises determining whether a query returns at least one match over tree structured data, the method comprising the steps of:

(a) converting the query into an equivalent automaton by decomposing the query into subqueries;

(b) running the automaton against a ranked tree representation of the tree structured data in a bottom-up manner and assigning to each subnode an indication of which subqueries match a subtree rooted at that subnode, and that subnode inheriting any indications assigned to its own subnodes;

(c) repeating step (b) until it is performed at the root node of the ranked tree representation of the tree structured data; and

(d) determining that the query matches the tree structured data if the root node is assigned an indication that each of the subqueries match.

If the query is an XPath query, then step (b) may further comprise also assigning to each subnode an indication of whether any sub-query which makes use of the following axis. This enables the handling of the semantics of the different XPath axes.

The method may further comprise calculating the selectivity of the query comprising the steps of:

associating a counter to each assigned indication of a subquery; and

incrementing the counter of the subquery when a subquery matches the subtree rooted at that subnode. Further a subnode may inherit the counter values of subqueries assigned to its own subnodes. The method may further comprise zeroing out a counter when multiple embeddings of nodes would otherwise increase the counter for the same matching subnodes.

The query may be a structural query such as an XPath query.

Running the automaton against the ranked tree representation of the structured data may comprise running the automaton against a compressed representation of the ranked tree. The compressed form may be created according to the method described above, that is, the compressed form is comprised of an ordered set of definitions that at one end has a terminal definition that does not refer to any definition and at the other end a start definition.

In yet another aspect, the invention comprises a method for determining a selectivity of a query over tree structured data, the method being performed on a compressed form of the tree structured data that is comprised of a set of definitions each defining part of the tree structured data, and where appropriate a definition refers to one or more definitions in the set of definitions, and the set of definitions includes a start definition that defines the tree structured data starting from a root node of the tree structured data, the method comprising the step of:

(a) converting the query into an equivalent automaton by decomposing the query into subqueries, each having an associated counter;

(b) running the automaton against the compressed form of the tree structured data starting from the start definition to determine whether any subqueries match the start definition and for each match of a subquery incrementing the counter of the subquery and determining whether any of the subqueries match any of the definitions referenced in the start definition and for each match of a subquery to a referenced definition incrementing the counter of the subquery, wherein the start definition inherits counter values of subqueries matched on definitions it references; and

(c) determining the selectivity of the query based on the counters of each subquery.

As appropriate, a definition may comprise input parameters. A definition referenced by the start definition may comprise input parameters. The step of determining whether any of the subqueries match any of the definitions referenced in the start definition may include passing to the definition referenced by the start definition input parameters determined in the start definition. The input parameters may be whether a subquery has or hasn't got a match in the start definition. Reference to a definition may be directly or indirectly (i.e., recursively).

The input parameters may include a counter for each subquery that match or do not match a definition. Where a definition referenced by the start definition comprises input parameters, the step of determining whether a subquery matches this referenced definition may comprise only determining whether there is match based on parameters passed from the start definition. In this way not all possibilities are calculated only those that are required by the start definition to determine whether all the subqueries match the start definition.

A definition referenced by the start definition may also reference a third definition. The definition referenced by the start definition may inherit matches, inherit counters and pass parameters to the third definition just as the start definition did to the definition referenced by the start definition.

The method may further comprise estimating the selectivity of a query where a definition from the set of definitions may include an indication that a further definition referenced by the definition has been deleted, as described above. For a lower bound selectivity of the query on the tree structured data, when determining whether any of the subqueries match a definition which includes an indication that a further definition has been deleted, the method comprises the step of assuming that there are no matches for the further definition and not incrementing the counter.

The method may further comprise estimating an upper bound selectivity of the query on the tree structured data. In this case, when determining whether any of the subqueries match a definition that includes an indication that a further definition has been deleted, the method comprises the step of assuming that the maximum number of matches would be found in the deleted definition and incrementing the counter accordingly. The maximum number may be determined from statistical information of the deleted definition, such as the size and height values of the deleted definition.

The step of determining whether any of the subqueries match any of the definitions referenced in the start definition may be performed recursively.

The method may be performed on a stored compressed representation of the tree structured data and may comprise the steps of decoding the first definition the end of which defines the start of the next definition. The method involves storing the location of the start of every processed definition during step (b).

A reference to other definitions can appear at arbitrary internal nodes inside a definition.

The invention further provides a method for updating a compressed representation of tree structured data, wherein the update is performed on a node of the tree structured data and the compressed representation is comprised of a set of definitions including a start definition that defines the tree structured data starting at a root of the tree and includes references to one or more antecedent definitions in the set of definitions, and at least one antecedent terminal definition that does not refer to any other definition, the method comprising the steps of:

(a) if the start definition includes a reference to an antecedent definition on a path from the root to the node to be updated, replacing the reference to the antecedent definition with a definition;

(b) repeating (a) until there is no reference to an antecedent definition on the path from the root to the node to be updated other than references to antecedent terminal definitions; and

(c) performing the update on the node.

In this way, the entire compressed representation does not need to be expanded, only those parts that define the path from the root to the node to be updated need to be expanded.

The method may further comprise the step of re-compressing the set of definitions. Re-compression of the ordered set of definitions may be performed according to the method of generating a compressed representation of tree structured data described above, such as identifying repetitions of subtrees and/or tree patterns consisting of at least two nodes and replacing them with a reference to a definition that describes the identified subtree or tree pattern. Further, the re-compression may include deleting definitions that are referred the least by other definitions.

The method of updating the compressed representation of the tree structured data may include queuing up updates to the tree structured data and performing the updates all together.

The set of definitions may include one or more antecedent definitions that also reference other antecedent definitions. The set of definitions

The update to the node may be inserting a first child to the node, inserting a sibling to the node or deleting the node and its dependent nodes.

The node to be updated may be identified using the Dewey notation system.

The terminal definition may define an a tree structure that is empty.

The path from the root to the node to be updated may include an indication that part of a definition has been deleted. The indication that a definition of a node has been deleted may appear in a definition as a special character described above. In this case, the method may further comprise replacing the indication that the definition of the node has been deleted with the definition. This may comprise the step of referencing an original set of definitions in which the definition of the node is not deleted.

The invention also provides computer software to perform any one or more of the methods described above. The further provides computer hardware having processing and storing means to perform any one or more of the methods described above.

Embodiments of the invention provide a new synopsis for XML documents which can be effectively used to estimate the selectivity of complex path queries. The synopsis is based on a lossy compression of the document tree that underlies the XML document, and can be computed in one pass of the document. It has several advantages over existing approaches: (1) it allows one to estimate the selectivity of queries containing all XPath axes, including the order-sensitive ones, (2) the estimator returns a range within which the actual selectivity is guaranteed to lie, with the size of this range implicitly providing a confidence measure of the estimate, and (3) the synopsis can be incrementally updated to reflect changes in the underlying XML database.

The synopsis can give selectivity estimates for any Core XPath [9] query, including those which make use of order-sensitive axes.

Unlike other selectivity estimation strategies, the approach of the invention returns a range within which the exact selectivity is guaranteed to lie. The confidence of the estimate is reflected in the size of the range. A smaller range naturally implies a greater degree of confidence in the answer. This is especially useful for query plan selection, as the query engine can take into account the confidence of the estimate when selecting plans.

In contrast to all previous work, our invention has the following advantages:

it is based on well-founded theoretical principles, and hence can be more easily extended to larger query classes than other approaches.

it can handle a very large class of queries.

it provides a lower and upper bound, and therefore provides an implicit confidence measure in the result.

it can efficiently handle updates.

despite all these additional features, its space requirements are highly competitive with existing approaches.

even though the structure provides all these additional features, it returns estimates that are competitive with the best existing techniques, while using a small amount of space. Thus, the synopsis of the invention provides a complete solution to the problem of selectivity estimation for structural queries on for example, tree structured data.

### BRIEF DESCRIPTION OF DRAWINGS

FIG. 1 shows a schematic drawing of the components of a database system (prior art).

Embodiments of the invention will now be described with reference to the accompanying drawings, wherein:

FIG. 2 shows an XML document tree D

FIG. 3 shows the counting of selectivity of a query on a XML document using tree automata

FIG. 4 shows a flowchart of creating and storing a synopsis

FIG. 4(a) shows counting selectivity using tree automata over an SLT grammar

FIG. 5 shows a (unranked) semantics of a tree *(tᵢ, t₂, t₃, h, s)

FIG. 6 shows a flowchart of selectivity estimation

FIG. 7 shows running of a tree automata on a ranked tree

FIG. 8 shows running of a tree automata on a ranked tree, where the query includes the following axis

FIG. 9 shows Algorithm 1 that describes a tree automaton transition function

FIG. 10 shows Algorithm 2 that describes a count-automaton transition function

FIG. 11 shows a flowchart of incremental updates

FIG. 12 schematically shows the effect of an insertion in a ranked tree

FIG. 13(a) shows packed encoding for a rule

FIG. 13(b) shows a table of characteristics of experimental data sets

FIG. 14 shows graphs of relative error versus number of deleted patterns

FIG. 15 shows graphs of update performance

FIG. 16 to FIG. 24 show detailed calculations for creating a synopsis, calculating selectivity and updating a synopsis in accordance with the invention

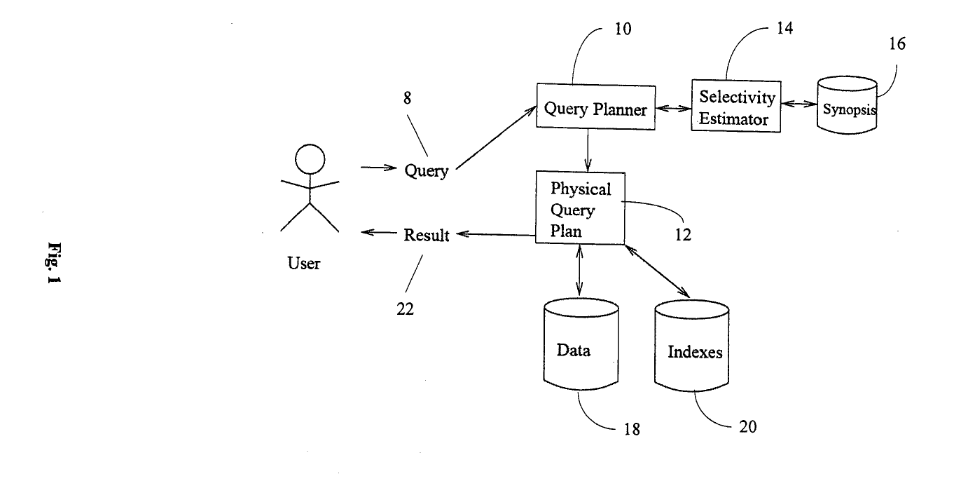

### BEST MODES OF THE INVENTION

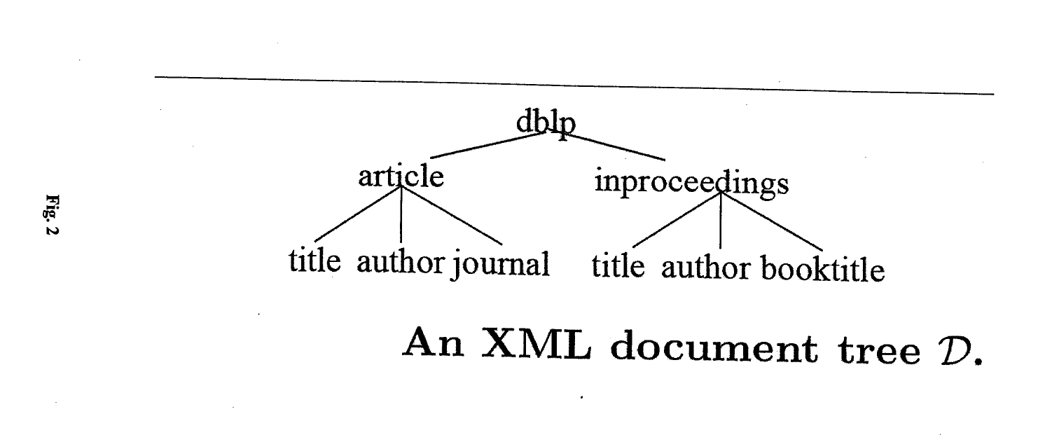

Documents Let D be the ordered, rooted, labelled, unranked tree corresponding to an XML document; for our purposes we can safely ignore attributes, node values, names-paces, processing instructions, and other features of XML (many of these can be handled by our results in a straight-forward fashion). By Σ we denote the alphabet of elements present in D; while in its full generality XML allows Σ to be countably infinite in size, we restrict it for convenience so that it is finite and |Σ|=O(1) (with respect to |D|). FIG. 2 gives an example of the structure of an XML document.

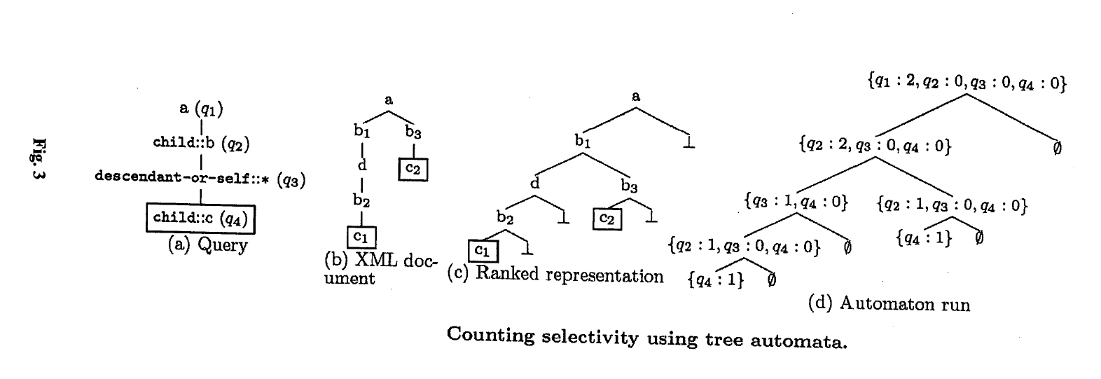

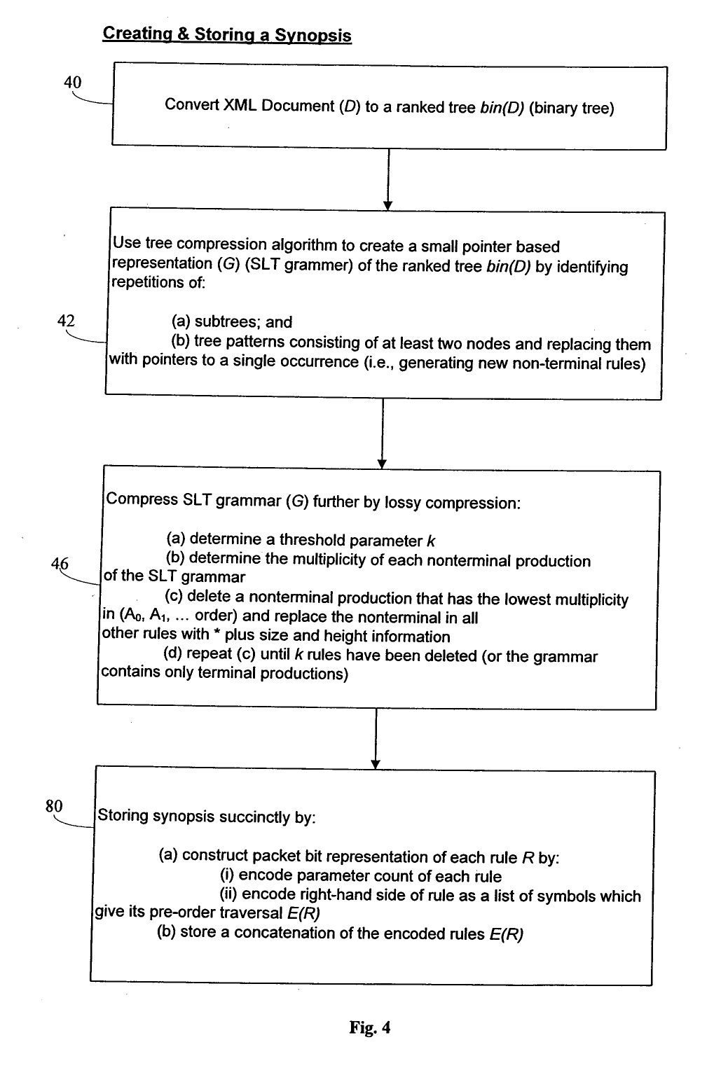

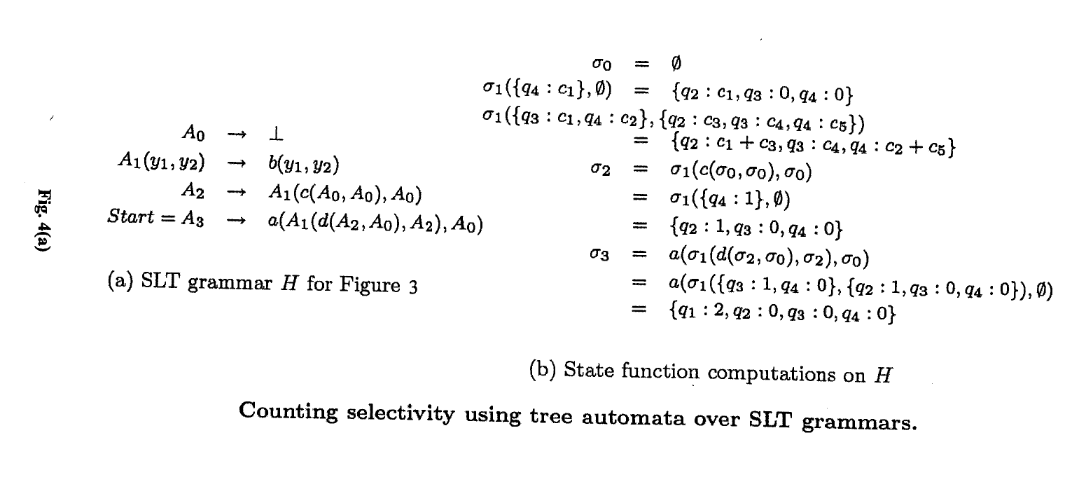

We shall represent XML documents using a binary, ranked representation bin(D) of D. The transformation into this representation is simple: the left edge of the binary tree represents the “first child” relationship, while the right edge represents the “next sibling” relationship. We use ⊥ to denote the empty tree, and write V_{D} for the vertices of the document (in the ranked representation), and λ: V_{D}→Σ for the mapping from vertices of the document to their labels. FIGS. 3(b) and (c) gives an example of the transformation of an XML document from the unranked to ranked representation.

Queries Core XPath is a powerful fragment of XPath that can be seen as the structural portion of)(Path. It consists of queries satisfying the following grammar:
path::=location_path|/location_path
location_path::=location_step (/location_step)*
location_step::=χ::t|χ::t[pred]
pred::=(pred [symbol] pred)|(pred [symbol] pred)
   ( [symbol] pred)|location_path

In this grammar, χ is an XPath axis (e.g., descendant, descendant-or-self, or child), and t is a node test (i.e., either t ∈ E or t=*). Note that the above grammar allows arbitrarily Boolean combinations of location paths as predicates in the query. For ease of presentation we will only consider conjunction here since the results presented here are easily generalized to handle other Boolean functions.

We will represent a core XPath query Q as a tree with root r_{Q}, vertices V_{Q} and edges E_{Q}, along with label functions λ_{V}: V_{Q}→Σ∪{*} and λ_{E}:E_{Q}→A, where A is the set of XPath axes. Since Q is a tree, each node q in Q has at most one parent—therefore, for convenience we write λ_{E}(q)=λ_{E}( [symbol] Parent(q), q [symbol] ). One of the vertices of Q, m_{Q} ∈ V_{Q}, is the match node. The semantics of an XPath query are well-known [7], and so we only briefly summarize them here. An embedding of a query Q in a document D is a tree homomorphism h: V_{Q}→V_{D} satisfying:
(∀u ∈ V_{Q})λ_{V}(u)=* or λ(h(u))=λ_{V}(u).
(∀(uᵢ, u₂) ∈ E_{Q}) (h(uᵢ), h(u₂)) satisfies the constraint specified by λ_{E}((u₁, u2)).

The constraints specified by X_{E} depend on the axis, but are straightforward. For instance, if λ_{E}((u₁, u₂))=child, then we require h(u₁) to be the parent of h(u₂) in D. The result of the query Q over D is then:

Q(D)={h(m_{Q})|∃ an embedding h of Q in D}

The problem of selectivity estimation is to estimate |Q(D)| for arbitrary queries Q.

While there are thirteen axes in XPath, several of these (e.g., namespace) are uninteresting as they can be handled in an analogous fashion to the others. The remaining axes can be divided into forward and reverse axes; here we need to consider only the forward axes as any query involving reverse axes can be rewritten into one using only forward axes. Additionally, it is trivial to rewrite the descendant axis in terms of the descendant-or-self and child axes. Hence, we consider the axes child, following-sibling, following, self, and descendant-or-self. Note that it is possible to extend our techniques to handle reverse axes more directly.

### The Synopsis

A method of creating a synopsis for use in selectivity estimation will now be described with reference to FIG. 4. The synopsis may be stored in storage means of a computer system. The storage means will also store the tree structured data that the query will be performed on. The synopsis and the storage means of the whole tree structured data are separate datastore. The computer system will also include input means to accept input of a users query and a processor to perform the processing. The processing of the query may be initially performed on the synopsis to confirm that there is match, the selectivity of the query and/or an upper and lower bound of the selectivity estimate. The result of the processing will then be displayed to the user on output means. Software is also stored in storage means of the computer system which operates the processor to perform the methods described herein. The software may be built into database application software program.

Initially, the XML Document (D) is represented as a ranked tree bin(D) 40. Then a tree compression algorithm is used to generate a small pointer-based representation of the (ranked) tree bin(D), called an “SLT grammar” (straight-line tree grammar) 42. For common XML documents the size of the obtained grammar, in terms of the number of edges, is approximately 5% of the size of D. We then decrease the size of this grammar further 46, by removing and replacing certain parts of it, according to a statistical measure of multiplicity of tree patterns. This results in a new grammar which contains size and height information about the removed patterns (this information will later be used to estimate selectivity). The two big advantages of SLT grammars over other compressed structures are: (1) they can be represented in a highly succinct way (as described in further detail below), and (2) they can be queried in a direct and natural way without prior decompression [13]. In particular, it is shown in further detail below in relation to selectivity estimation how to translate XPath queries into certain tree automata which can be executed on SLT grammars.

### Tree Compression Using SLT Grammars 42

Most XML documents are highly repetitive. The same tags appear again and again, and larger pieces of tag markup reappear many times in a document. One known idea of removing repeated patterns in a tree is to remove multiple occurrences of equal subtrees and to replace them by pointers to a single occurrence of the subtree. In this way, the minimal unique DAG (directed acyclic graph) of a tree can be computed in linear time. For most document trees, the size of the minimal DAG is approximately 10% of the size of the original tree (where size is measured as the number of edges).

The idea of sharing common subtrees can be extended to the sharing of connected subgraphs in a tree. For example, in the tree c(d(e(u)), c(d(f), c(d(a), a))) only the subtree a appears more than once; however, the tree pattern “c(d(” appears three times in the tree. The idea of sharing tree patterns gave rise to the notion of sharing graphs. The problem of finding a smallest sharing graph for a given tree is NP-complete. The first approximation algorithm for finding a small sharing graph is the BPLEX algorithm as set out in [5]. Instead of sharing graphs, it produces isomorphic structures called Straight-Line context-free Tree grammars (SLT grammars). In such a grammar, a pattern is represented by a tree with formal parameters y₁, y₂, . . . . For instance, the pattern “c(d(” above is represented by the tree c(d(y₁), y₂). Each nonterminal A of the grammar has a fixed number r(A) of formal parameters y₁ . . . yₖ, called its rank. We call a finite set N together with a rank mapping r a ranked alphabet. A rule is of the form A(y₁, . . . , yₖ)→t where t is a tree in which the formal parameters may appear at leaf nodes. We will only deal with grammars where each parameter appears exactly once in t.

Definition 1 (SLT Grammar). An SLT Grammar G (over Σ) is a tuple (N,Σ,R), where N={A₁, . . . , Aₙ} is a ranked alphabet of nonterminals and R is a set of rules. For each Aᵢ ∈ N of rank k the set R has exactly one rule of the form Aᵢ,(y₁, . . . , yₖ)→t, where t is a ranked tree over ∈, N, and y₁, . . . , yₖ, which are parameters appearing at the leaves of t, each exactly once, and in order (following the pre-order of t). Moreover, for any Aⱼ ∈ N, if Aⱼ occurs in t then j<i.

The definitions (i.e. rules or productions) of G are used as term rewriting rules in the usual way (inducing a rewrite relation [symbol] G). The nonterminal Aₙ is the start nonterminal. An SLT grammar G produces (at most) one tree, because the indices of nonterminals strictly decrease (and hence no downward recursion is possible). For instance, the SLT grammar with rules:
A₁ (y₁, y₂)→c(d(y₁), y₂)
A₂→A₁(e(u),A₁(f,A₁(a,a)))
   generates the aforementioned tree. This can be seen by beginning with the start nonterminal A₂, and applying rules until no nonterminals remain:
A₂ [symbol] G A₁(e(u),A₁(f,A₁(a,a)))
[symbol] G A₁(e(u),A₁(f,c(d(a),a)))
[symbol] G A₁(e(u),c(d(f),c(d(a),a)))
[symbol] G c(d(e(u)),c(d(n,c(d(a),a)))

The BPLEX algorithm is described in detail in Busatto et al. In order for BPLEX to run in linear time, it is controlled by three parameters: the maximal rank that it gives to nonterminals, the maximal size of a pattern (=right-hand side), and the window size (=the number of rules that it scans when looking for existing patterns).

Let us explain how BPLEX works on an example. Every grammar generated by BPLEX contains the special nonterminal A₀ which generates the empty tree ⊥. Running BPLEX on the tree c(d(e(u)),c(d(f),c(d(a),a))) produces this SLT grammar:
A₀→⊥
A₁→a
A₂ (y₁, y₂)→c(d(y₁), y₂),A₀)
A₃→A₂(e(u,A₀),A₂(f,A₂(A₁,A₁)))

Taking the binary encoding into account, this is basically the grammar that was shown before. BPLEX first looks for repetitions of subtrees and shares them by introducing nonterminals. In our example it introduces A₁ and replaces the two occurrences of a by A₁. Next, BPLEX traverses this “DAG grammar” bottom-up searching for the repetition of a tree pattern consisting of at least two nodes; if it finds one, it introduces a new nonterminal, adds a corresponding rule, and replaces the occurrences of the pattern by the new nonterminal. In our case, when the second c node is visited, coming from below, A₂ is introduced, and we obtain A₂(f,A₂(A₁,A₁)). When BPLEX moves further, it first looks for repetitions of patterns that are already in the grammar, and then looks for new patterns. At the root, it finds another occurrence of the c(d(pattern and replaces that by A₂.

### Lossy Compression 46

Consider an XML document tree D and an SLT grammar G representing bin(D). We want to reduce the size of G in such a way that the result can be used for selectivity estimation. The idea is to keep the parts of the document tree that appear frequently (at many different positions in bin(D)), and to remove parts that appear infrequently. When we remove a part, we replace it by a special symbol *, which additionally carries information about the height and size of the removed pattern. As parts we simply take the right-hand sides of the rules of G. Let k be a natural number, which we call the threshold parameter.

The threshold parameter determines how many productions will be removed (at most) from the grammar. The A₀-production is never deleted. First the productions with the lowest multiplicities are deleted, in the order A₀,A₁, . . . of the grammar. This process is repeated until k productions are deleted (or the grammar only contains the A₀-production). In this way we obtain a (k-) lossy grammar (for G).

The multiplicity of Aᵢ is the number of times that A, is generated during the derivation of bin(D) by G (see below for how to compute this number). Deleting the nonterminal Aᵢ from G means removing its rule Aᵢ(y₁, . . . , yₖ)→t, and (recursively) replacing in all other rules any subtree Aᵢ(t₁, . . . , tₖ) by the tree:

$$\{ \begin{matrix}* ( {t}_{1} , … , {t}_{k} , h , s ) , & if right \text{-} most leaf of ex ( t ) is {y}_{k} \\ * ( {t}_{1} , … , {t}_{k} , ⊥ , h , s ) , & otherwise\end{matrix}$$

where h and s are the height and size, respectively, of the unranked tree corresponding to the tree ex(t) generated by Aᵢ, i.e., the tree u with t [symbol] G . . . [symbol] G u [symbol] G. The numbers h and s are stored to later give over-estimates of selectivity. Since we are working on binary trees, u represents a sequence w of trees in the unranked representation; if yₖ is the right-most leaf of ex(t) then the last parameter tree tₖ of Aᵢ(t₁, . . . , tₖ) will be the last tree in ω.

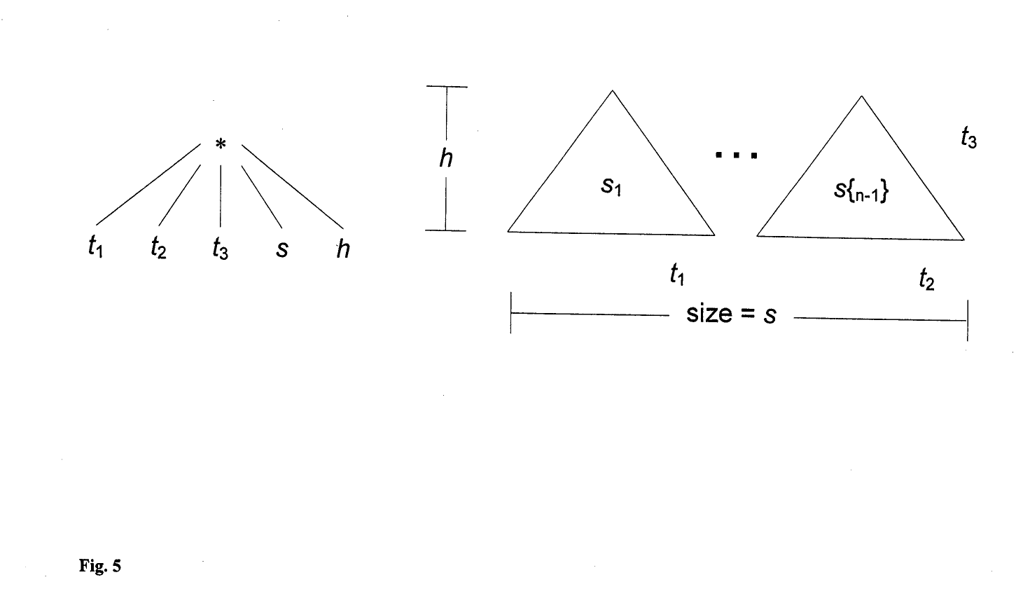

The (unranked) semantics of a tree *(t₁, t₂, t₃, h, s) is depicted in FIG. 5. It represents any sequence s₁,s₂, . . . , sₙ of trees such that: (1) the sequence sᵢ, . . . , s{ₙ₋₁} has subtrees t₁ and t₂, (2) the last tree of the sequence sₙ equals t₃, (3) the height of the sequence is h, and (4) the size of the sequence is s. As an example, consider the grammar G produced by BPLEX discussed above. Let us take k=1 and construct a k-lossy grammar for G. The nonterminal A₁ will be deleted because it has the lowest multiplicity (=2). Since A₁ generates a which has size and height equal one, we replace occurrences of A₁ by the tree *(1, 1). In this way we obtain the following grammar:
A₀→⊥
A₂ (y₁, y₂)→c(d(y₁, y₂),A₀)

A₃→A₂(e(u,A₀),A₂(f,A₂(*(1,1),*(1,1))))

As another example consider a nonterminal A₅, with rule A₅(y₁, y₂)→c(d(y₁, e), y₂) which is selected to be deleted. If A₇ is not deleted and has the rule A₇→A₃(A₅(A₂,A₁)), then this rule will be changed in the lossy grammar into A₇→A₃(*(A₂,A₁, 3, 2)). However, if the A₅ rule was A₅(y₁, y₂)→c(d(y₁, y₂),e), then the A₇ rule would be changed into A₇→A₃(A₂,A₁,⊥, 3, 2)).

In order to replace nonterminals by stars, according to the value of k, we must compute for each nonterminal its multiplicity, i.e., the number of times that it is generated during the derivation of the grammar. This can be done in one pass through the SLT grammar G as follows. The nonterminal Aₙ has multiplicity one. For each nonterminal that occurs m≧1 times in t, we set its multiplicity counter to m. We now move to the nonterminal Aₙ₋₁. If its multiplicity counter is c≧1 then for each nonterminal that appears m′≧1 times in Aₙ₋₁'s right-hand side we set the corresponding multiplicity counter to c·m′. We proceed with Aₙ₋₂, . . . , A₁ in the same way. Similarly, it is possible to compute the size of the tree that is generated by a given nonterminal. For computing the height of a right-hand side, for each occurrence of a nonterminal of rank r≧1 we must additionally take into account the lengths of the paths from the root of its right-hand side to the different parameter leaves.

Selectivity Estimation

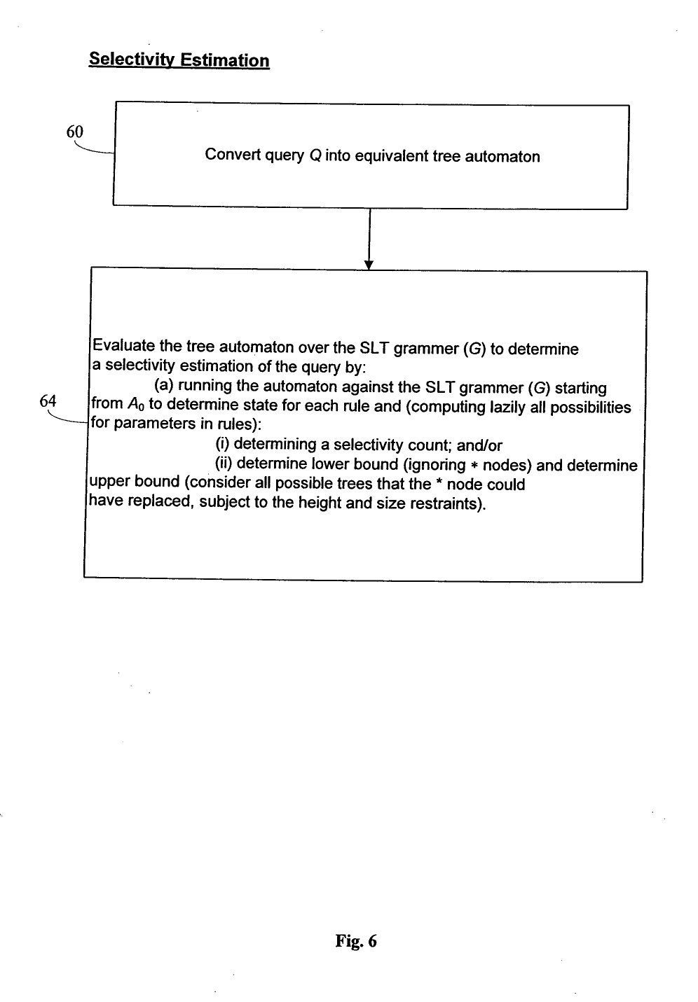

Here we describe our selectivity estimation technique over SLT grammars with reference to FIG. 6. We first consider the conversion of an XPath query into an equivalent tree automaton, and describe how to evaluate this tree automaton over a document to test whether the query has at least one match in the document (i.e., whether the query accepts the document). We then extend the standard tree automaton to also return the size of the result of the query on a document. Then, the algorithm is generalized to work over SLT grammars. The final step is to handle lossy SLT grammars which contain *'s in rules.

Definition 2 (Tree Automaton). A deterministic tree automaton over ranked tree encodings is a tuple (P, Σ, δ, F), where P is a finite set of states, Σ is the alphabet, δ: P×P×Σ→P is the transition function, and F⊂P is the set of final states.

A tree automaton is run on a tree in a bottom-up fashion as follows: the empty trees (⊥) which appear at the leaves of the tree are assigned the empty state, Ø. We then move upwards in the tree, so that a node with label a whose children have been assigned states p₁ and p₂ is assigned the state (p₁, p₂, a). Once the automaton has reached the root node, and assigns it state pᵣ, we can determine whether the automaton accepts the document by testing whether pᵣ ∈ F.

### Converting Queries to Tree Automata 60

The translation of a core XPath query into a tree automaton is based upon the observation that core XPath queries can be evaluated in a bottom-up fashion on a document. For instance, consider the query q=//article[.//title][.//author] find any article node that has descendants author and title. This query can be decomposed into three sub-queries: q itself, q₁=//title, and q₂=//author. Working in a bottom-up fashion on the document tree in FIG. 2, we can assign to each node in the database the subset of queries {q, q₁, q₂} which match the subtree rooted at that node. This is easy to do, since, for instance, we know that q matches the document if both q₁ and q₂ match the left child, and if the label of the node is article. Recalling that we are working on the ranked, not unranked representation, the full calculation is shown in FIG. 7.

The only axis which presents any significant difficulties is the following axis, as this introduces dependencies on nodes outside the subtree under consideration. For instance, consider the (contrived) query q=//author/following::title, which has the sub-query q′=//following::title. Clearly, in FIG. 2 the author node of the article lies in the result set of this query. In a bottom-up traversal of the query, however, this can only be determined once we reach the least common ancestor of this node and the title node of the inproceedings element (i.e., the root node of the document).

This problem can be addressed by keeping track not only of the matching sub-queries at each node, but also whether or not we have matched, for each of those nodes, any sub-query which makes use of the following axis. Thus, instead of keeping track of subsets of Q={q, q′}, we keep track of sets of items from Q×2Q; the query accepts the document if <q, {q′}> lies in the set at the root. A run on the ranked representation of FIG. 2 results in the calculation shown in FIG. 8.

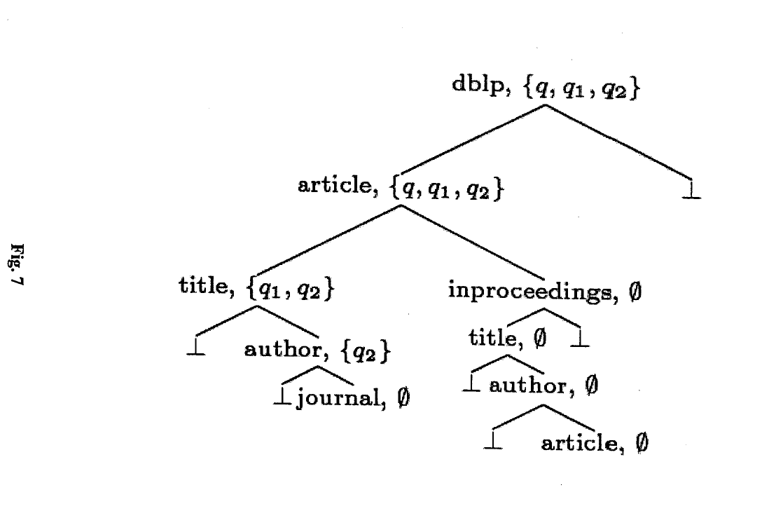

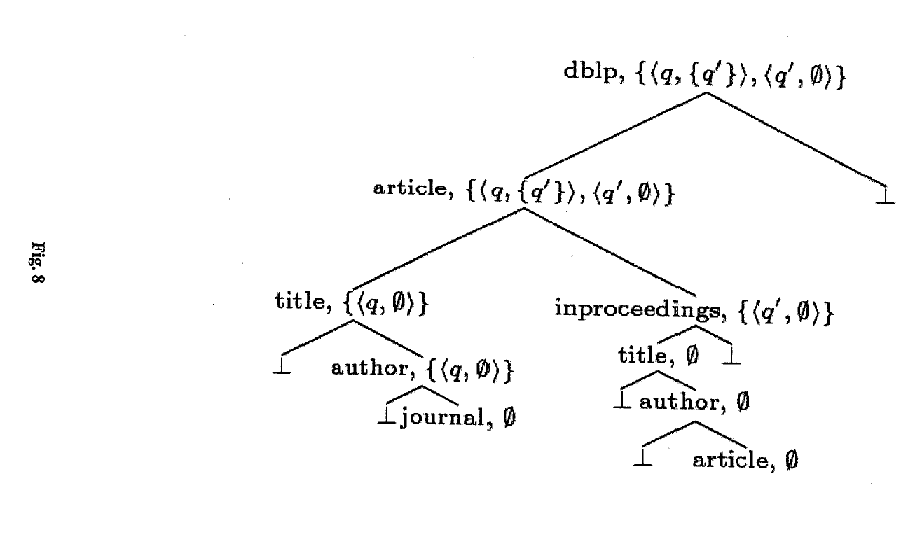

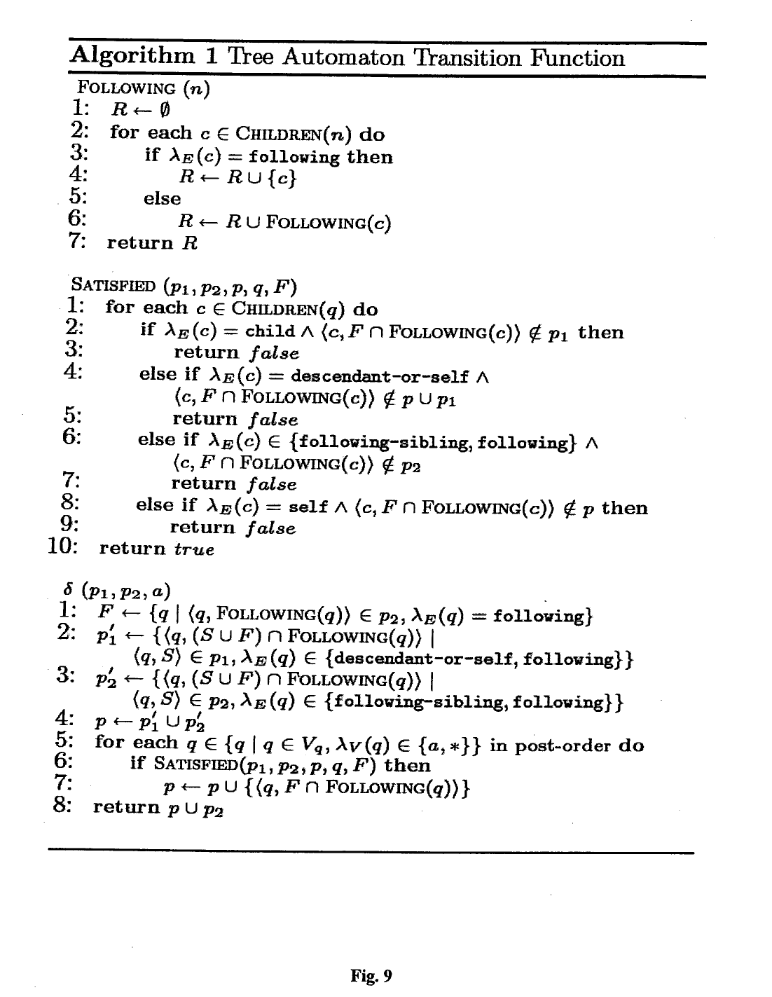

We now formalize this intuitive description. Given a query Q, our tree automaton has state set P=2^{Q}×2^{Q}, final states F={p|p ∈ P, (r_{Q}, FOLLOWING (r_{Q})> ∈ p} (see Algorithm 1 of FIG. 9 for FOLLOWING), and transition function as given in Algorithm 1. Much of the complexity in Algorithm 1 is simply due to the differences in handling the semantics of the different axes, especially following.

Counting with Tree Automata

Once we have a tree automaton for a query Q, testing whether there is a match for Q in a given document is straightforward, as we have seen above. However, in the context of selectivity estimation, we do not want to test acceptance, but instead want to return the size of result of the query. H. Seidl. [22] developed a framework for finite tree automata with cost functions which addresses such problems: each transition in the automaton is assigned a cost, and the task is then to find the “cheapest” accepting path. We will use a similar technique here.

When running our automaton on a document, we must now keep more information in each state, in order to keep track of selectivity. To this end, we associate with each state p in our automaton a set of counters. Our annotated state <p, C>, consists of a normal state, p ∈ 2^{Q×2}^{^{Q}}, and an array of counters, so that C[<q, F>] is the counter for each (q, F) ∈ p. We will assume that C[<q, F>]=0 if <q, F> ∉ p. Each counter represents the number of nodes matching the corresponding subquery, that have not already been matched by that subquery's parent query. As we move up the query tree, we can use the counters for the sub-queries to compute the selectivity of each query node.

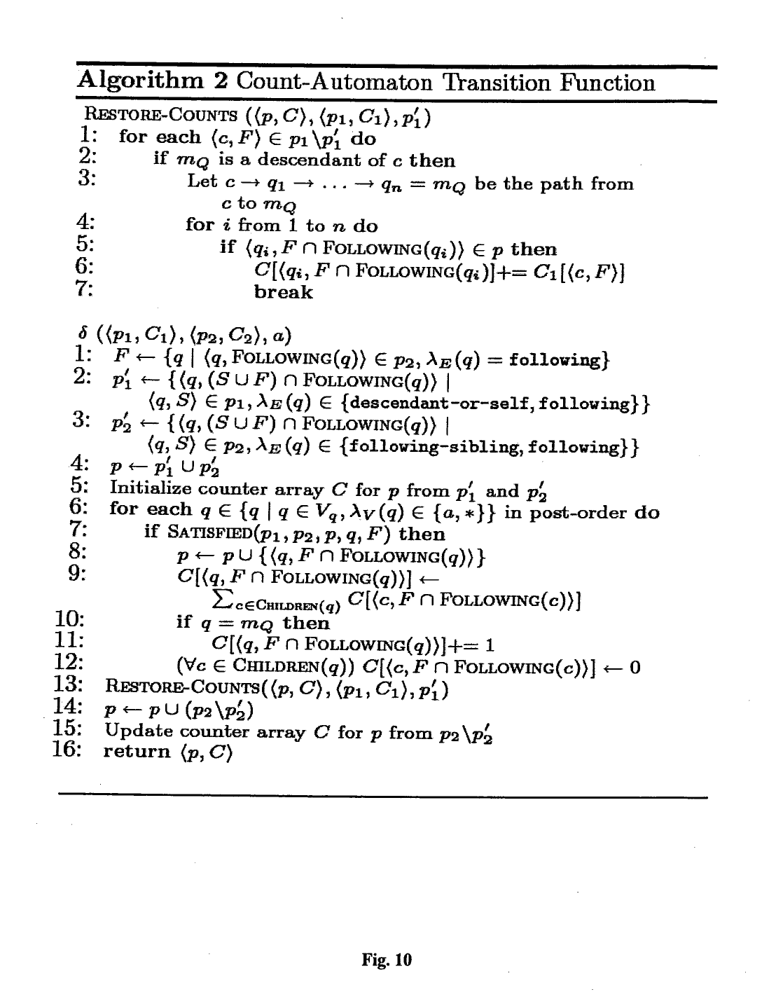

In order to maintain selectivity information, we extend the transition function to handle annotated states, as shown in Algorithm 2 of FIG. 10. The counting is relatively straightforward—we count the number of nodes matching the match node of the query, and propagate these counts up the query tree as required. FIG. 3 gives an example run of our algorithm (since there are no following axes present in the query, we have used the simpler state type).

There are two issues that are worth mentioning. When we match a new query node, the match count for that query node is clearly the sum of the counts of its children. However, once we have copied over the children counts, we must zero them out as well. This is to prevent double-counting, which occurs when multiple embeddings of a query in the document yield the same match node. For instance, in FIG. 3(b), the node c₁ is matched by two embeddings of the query in Figure (a); at node b₂, however, we set q₄: 0 in order to count only one embedding. The second (related) issue can be seen in the transition from the element b₂ to the element d in the document. Since the parent of b₂ does not have label a, q₂ is no longer a matching subquery—however, its child, the subquery q₃, is a matching subquery. Therefore, when removing q₂ from the set of matching subqueries, we must transfer its count of matching nodes back to q₃. This is the purpose of the function RESTORE-COUNTS in Algorithm 2 of FIG. 10.

### Tree Automata Over SLT Grammars 64

Up till this point we have considered tree automata running over a document. The following description demonstrates how to evaluate tree automata directly over SLT grammars, so that we can compute selectivity in time proportional to the size of the SLT grammar used to represent the document. Since this is much smaller than the document, it provides a feasible way of determining selectivity.

Again, we first consider the problem of acceptance, instead of selectivity computation. The main obstacle to running tree automata over SLT grammars is the handling of parameters in rules—since these can represent anything, we do not know what states they will take when evaluating the automaton on a rule.

The natural solution is to simply compute all possibilities. If we are considering a rule A₁(y₁, . . . yₖ)→t, then we can define a function σᵢ(p₁, . . . , pₖ)→P which gives the state for t, assuming the parameters map to the states p₁, . . . pₖ. In defining the function σᵢ, we will need to make calls to the functions σⱼ for all rules that the rule for Aᵢ makes use of—however, at that point we know exactly what states to pass in as parameters to these functions. Extending this to selectivity counting poses an additional problem: when computing the result of a query, one must incorporate the selectivity counts from the parameters. This can be done by manipulating the counters for parameter states symbolically. As can be seen in Algorithm 2 of FIG. 10, we only ever perform additions and the zeroing out of counters. Thus, if we treat the counters of the states corresponding to each parameter as unknown variables, then the selectivity count for the rule will be a linear function over these counters. This function, fᵢ(p₁, . . . pₖ)→Z, can be determined by a natural extension to Algorithm 2 of FIG. 10, and hence it is easy to extend a, to also compute fᵢ. When we come across a non-terminal Aᵢ(t₁, . . . , tₖ) in the right hand side of a rule, we can compute its state by first recursively determining the states p₁, . . . pₖ corresponding to the input parameters, and using these and σᵢ to determine the corresponding state (and selectivity counts) for the nonterminal.

FIG. 4(a) demonstrates the computation and use of the functions σᵢ when evaluating the query of FIG. 3(a) over an SLT grammar for FIG. 3(c). FIG. 4(a) shows the SLT grammar for the ranked representation of FIG. 3(c). We run through the rules in a bottom-up fashion (from A₀ to A₃), using the functions σⱼ for j<i to compute the state for rule Aᵢ. For rules with parameters, we do not compute all possible values for the functions σᵢ but only those that are actually needed. This can be most easily seen by considering a top-down run through the grammar: we begin with rule A₃. To compute the state for the root node (A₃ to A₀), we first need to compute the states for its two children, which are the two grammar fragments A₁(d(A₂,A₀),A₂) (corresponding to the subtree at b₁) and A₀ (corresponding to the empty tree). To compute the state for the first fragment, we must then compute the value of σ₁(d(σ₂, σ₀), σ₂); this computation is deferred until we know the values of σ₂ and σ₀. We continue by recursing top-down, using dynamic programming to ensure that we do not evaluate the same value twice. As can be seen in FIGS. 4(a) and (b), the function σ₁ only needs to be computed for two different argument values.

Determining complexity is straightforward. If every rule has at most k parameters, then we have:

Theorem 3. Selectivity counting over a straight-line grammar G with k parameters by a deterministic tree automaton with state set P takes time O(|P|^{k}−G|).

It is worthwhile relating the size of the state set P back to the size of a query. Clearly, |P|=O(2^{2|Q|}), but in practice |P| is much smaller. If we assume there are no following axes present in the query, then we can make this observation. If a node q lies in a state p, then all of q's descendants in the query also lie in p. This means that if we have a query which has at most b branches, then there are only (|Q|/b)^{b} different possible states. If we also have m following axes in the query, then these increase the number of states by a factor of 2^{m}. Therefore we have:

Theorem 4. Determining acceptance of a straight-line grammar G with k parameters by a query with branching factor b and m following axes takes time

$$O ( {( \frac{\vert Q \vert}{b} )}^{bk} {2}^{mk} \vert G \vert )$$

In practice, BPLEX returns very small grammars even with a very low value for k (such as k≦2), and so we can ignore this dependency. Also, the branching factor of queries is usually quite low, and we suspect that the occurrence of following axes in queries is infrequent. Finally, note that we do not need to explicitly compute all possible values for the functions σᵢ, but instead can lazily compute only those values needed. We find that in practice only a small number of combinations of states are seen, and so this algorithm runs quickly. In FIG. 4, for example, only 2 out of 16 possible values for the function σ₁ are computed. Thus, the worst case bounds are generally not reached in practical situations.

### Tree Automata Over Lossy Grammars

Running tree automata over lossy SLT grammars is identical to running them over SLT grammars, except for the handling of * nodes. In this case, we provide two alternative mechanisms for computing selectivity. These two methods lead to lower and upper bounds on the actual selectivity.

With lower bounds the most straightforward approach to handling * nodes is to simply ignore them—since this means we miss some nodes in the underlying database, computing selectivity in this fashion necessarily leads to a lower bound on the actual selectivity. In this case, the transition function can be easily given in terms of the function of Algorithm 2 of FIG. 10. For a * subtree *(t₁, t₂, . . . , tₖ, h, s), it suffices to run the transition function already given on a tree of the form *(*( . . . (*(*(t₁, t₂), t₃) . . . ), tₙ₋₁), tₙ).

With upper bounds the basic idea is that when the tree automaton reaches a * node, it must consider all possible trees that the * node could have replaced, subject to the height and size constraints. It is possible to do this in time linear in the height of the replaced tree. Due to the flat nature of real world XML, the height of the replaced tree is very small, and this imposes significant constraints on the possibilities. Even in the event that there are many possible trees, the total contribution from a * node to the selectivity estimate is bounded above by the number of nodes in the tree it replaced.

There is one optimization which we found boosted the accuracy of the upper bounds generated by our scheme considerably. For each element label a ∈ Σ, it is trivial to compute the set of element labels that occur as children of elements a in the XML document. This information, which adds very little to the overall space cost of the synopsis, can be used to prune the number of possibilities in a * node considerably. For instance, if we know that the set of possible children of an element a are {b, c}, and if we are considering a * node that is a child of an a element, then the root node of the tree replaced by the * node must have been labelled either b or c. We can apply this procedure recursively up to the height bound h. When combined with the fact that the query often only involves a handful of unique element labels, this can have a dramatic effect on the quality of the upper bound estimates.

### Incremental Updates

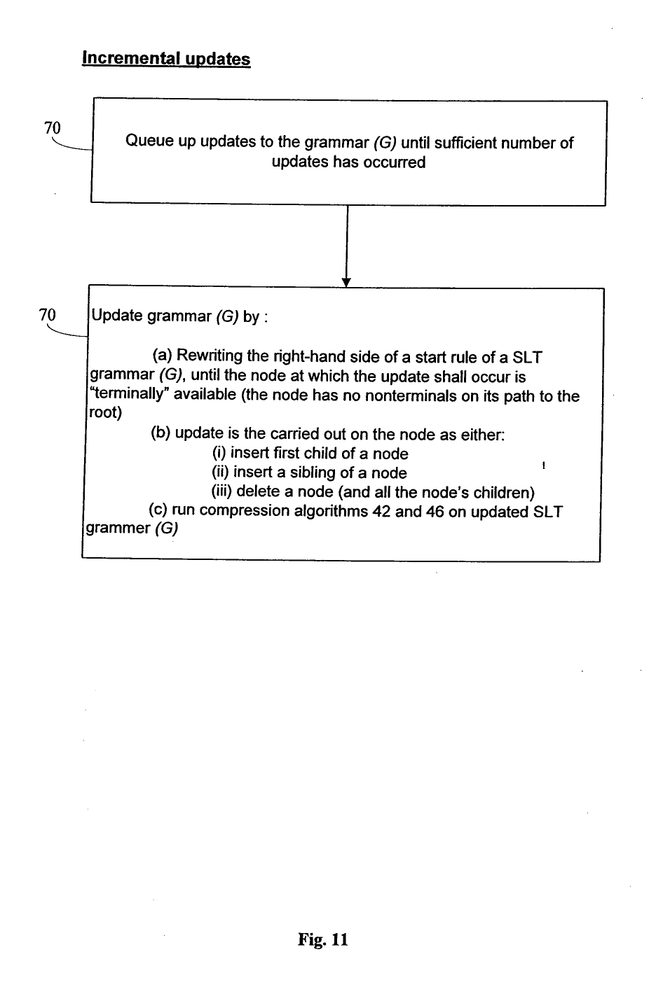

To date, the update problem has not yet been considered for SLT grammars. In reference to FIG. 11 we present an effective update algorithm for lossless SLT grammars. We then extend our synopsis structure to a two-layer data structure:

The lossy synopsis structure we have presented so far is stored, in a compact form in memory as described later.

An equivalent lossless SLT grammar is stored on disk.

When updates occur in the database, we update the grammar using the algorithms presented in this section. In order to minimize disk accesses, we can queue up updates to the structure 70, thus letting it get out of date for short periods of time. Once a sufficient number of updates to the grammar has occurred, we can recompute the in-memory synopsis in a single pass over the disk-based grammar. Since the disk-based grammar is still substantially smaller than the complete document, we can construct a new lossy synopsis quickly.

Clearly, we do not want to decompress the grammar into the document tree, do the update there, and then compress it back into a grammar. Instead, we would like to have an incremental way of doing updates directly on the grammar. Incremental updates can be achieved by rewriting the right-hand side t of the start definition Aₙ→t of the grammar, until the node at which the update shall occur is “terminally” available. The latter means that the path from the root to this node does not contain any nonterminals. When we know that the current node is not shared by other nonterminals, the update can be carried out at the node.

The update operations we consider are: the insertion of a new tree as the first child of a node, as the next sibling of a node (which means as the right child in our ranked setting), and the deletion of a subtree (which means the deletion of a node and its left subtree in the ranked setting). The effect of an insertion as the first child and as the next sibling of a node u in a ranked tree is shown in FIG. 12.

After an update has been realized on the (partially rewritten) right-hand side of the start production, we run the BPLEX compression on this tree, replacing patterns that already appear as right-hand sides in the grammar by corresponding nonterminals, and possibly introducing new rules for newly found patterns that appear multiple times. As we will see in the experimental section, updates done in this way do not increase the size of the grammar significantly, and the increase in size stays constant even as the number of updates increases. Hence, we never have to go back to the XML document (database) and recompute a new grammar from scratch. Obviously, only linear time is needed for an update.

Theorem 5. The insertion of a tree t into D can be realized on the SLT grammar G (for bin(D)) in time O(|G|+|t|), and the deletion of a subtree of D in time O(|G|).

More concretely, we use three different update operations. Clearly they suffice to express any form of update to the document tree. The operations are:
first_child bind_path tree
next_sibling bind_path tree
delete bind_path
   where bind_path is a node in the ranked document tree in binary dotted decimal notation (Dewey notation), and tree must be a tree with right-most leaf ⊥. Note that bin(W) for any sequence W of document trees is always of this form. The set of nodes Dewey(t) in bindd notation of a binary tree t=c(t₁, t₂) is {ε} ∪ {id|d ∈ Dewey(t,), i ∈ {1, 2}}, and {ε} if t=d for some symbol d of rank zero, where ε denotes the empty sequence. We use binary Dewey notation since it can be easily derived from a normal Dewey encoding. However, it is important to note that this is only one possible means of linking between nodes in the database and nodes in the synopsis. An alternate strategy would be to label each node in the synopsis with a unique identifier and have nodes in the database point to the node in the synopsis within which they lie. The method of linking between the database and any index or synopsis structure is obviously highly implementation dependent, but such a mechanism is required for any updateable structure.

As an example, consider the grammar previously used:
A₀→⊥
A₁→a
A₂ (y₁, y₂)→c(d(y₁, y₂),A₀)
A₃→A₂(e(u,A₀),A₂(f,A₂(A₁,A₁)))
   and the update operation delete 1.2.1 which is the second node. We have to rewrite the right-hand side of the start rule until the node 1.2.1 has no nonterminals on its path to the root. We apply the rule for A₂ at the root node and rewrite:
A₂(e(u,A₀),A₂(f,A₂(A₁,A₁))) [symbol] G
   c(d(e(u,A₀),A₂(f,A₂(A¹,A₁))),A₀)

Since node 1.2 is still nonterminal, we rewrite it and obtain: c(d(e(u,Aₒ), c(d(f,A₂(A₁,A₁)),A₀)),A₀)_{.} Now the node 1.2.1 is terminally available and can be deleted. We obtain the tree c(d(e(u,A₀), c(A₂(A₁,A₁)),A₀)),A₀). Finally, BPLEX is run on this right-hand side, i.e., it searches for existing and new patterns. When BPLEX reaches the root node of the tree, it detects the pattern c(d(y₁, y₂),A₀) which exists as right-hand side of A₂. It replaces it and we obtain the tree A₂(e(u,A₀), c(A₂(A₁,A₁),A₀)). The final grammar after the update is:
A₀→⊥
A₁→a
A₂ (y₁, y₂)→c(d(y₁, y₂),A₀)
A₃→A₂(e(u,A₀),c(A₂(A₁,A₁),A₀))

Next, we consider an insertion (on the original grammar). We want to insert the tree e(u) as first child of the second d node, i.e., we want to execute first_child 1.2.1 e(u). As for the delete, we first rewrite the start right-hand side until no nonterminals are on , the path to the root node. As before, we obtain c(d(e(u,A₀), c(d(f,A₂(A₁,A₁)),A₀),A₀). Now we insert e(u) as the new first child of the second d node. We get c(d(e(u,A₀), c(d(e(u,f), A₂(A₁,A₁)),A₀)),A₀). Finally, we run BPLEX on this tree. This time it discovers a new pattern e(u, y₁) that appears twice; it therefore adds the new nonterminal A₃. The final grammar after update is:
A₉→⊥
A₁→a
A₂ (y₁, y₂)→c(d(y₁, y₂),A₀)
A₃→(y₁) e(u,y₁)
A₄→A₂(A₃(A₀),A₂(A₃(f),A₂(A₁,A₁)))
   The next_sibling update works analogously to first_child.

### Succinct Synopsis Storage

At this point, we have an SLT grammar G, which has already been made lossy, and hence has * nodes. The natural in-memory representation of such a structure is to have a list of rules, with the right-hand side of each rule stored in a pointer-based tree data structure. However, this representation provides substantially more power than we really need: a pointer-based tree structure allows access to (child/sibling) nodes in constant time. Since a bottom-up tree automaton can be easily implemented by a depth-first, left-to-right tree traversal, we only need to have constant time access to the root node of the right-hand side of each rule. Thus, we can compress the synopsis considerably by using a more sophisticated representation. Here, in reference again to FIG. 4, we will first consider the case of a static synopsis, and then extend this data structure to allow efficient updates.

The Static Case: we recall the following properties of our synopsis and estimation algorithm:

When evaluating a rule Rᵢ=Aᵢ→t of G, the estimation algorithm only needs to access rules Rⱼ where j≦i.

When evaluating a rule R, the estimation algorithm runs through the right-hand side in a single post-order traversal.

For a rule R with k parameters, each parameter is used only once, and the parameters appear sequentially in a pre-order traversal of the right-hand side of R.

We take advantage of these properties to construct a packed representation for the synopsis. For each rule R, we construct a packed bit encoding E(R), and then encode the entire synopsis as the concatenation E(R₀)·E(R₁)· . . . ·E(Rₙ). When running a tree automaton over the synopsis, we start by decoding the first rule, R₀. Once we have decoded rule R₀, we know where rule R₁ starts; more generally, once we have decoded rule Rᵢ, we know where rule Rᵢ₊₁ starts. Since the tree automaton runs in a bottom-up fashion, when it has reached rule Rᵢ it will have all the information necessary to process this rule, as long as it remembers the start locations of all the rules it has seen up to that point (needed for the “lazy computation” described above).

In addition to the packed representation above, we maintain a lookup table to further reduce the size of the representation of * subtrees. Recall that each * node has associated with it two statistics, the height h of the replaced tree, and the number s of nodes replaced. We construct an array S[i] consisting of all unique tuples (h, s) (since * nodes often replace patterns that occur more than once, it is likely that a fixed <h, s> will occur more than once in the grammar). When we reach a * node, we can use the appropriate offset into this array instead of explicitly listing h and s.

For a rule Rᵢ with k parameters, we construct E(Rᵢ) as follows: first, add k ones followed by a zero bit to encode the parameter count. Following this we encode the right-hand side of the rule as a list of symbols in accordance with a symbol tree, which give its pre-order traversal. There are four possibilities for the first symbol:

A call to a rule Rⱼ(t₁, t₂, . . . , tₖ),j<i: there are i−1 possible rules that can be called from Rᵢ.

A terminal a(t₁, t₂): there are |Σ| possibilities.

A star or a parameter: in each case, there is only one possibility.

Thus, we can encode all possibilities in log(|Σ|+i+1) bits. The remaining encoding then depends on each of the possibilities:

For a rule Rⱼ (t₁, t₂, . . . , tₖ) or terminal a(tᵢ, t₂), we simply recurse the encoding algorithm on each subtree t₁, t₂, . . . tₖ, and store the concatenation of these encodings. In both cases we know exactly how many parameters there are, and hence do not need to encode this information.

For a * subtree *(t₁, . . . , tₖ, h, s), the number of parameters is variable. Therefore, in addition to storing the appropriate offset into the lookup table S, we must store the encodings of the k subtrees, as well as k itself One way of doing this is to prefix the encoding of each subtree with a single 1 bit, and terminate the list of parameters with a 0 bit.

FIG. 13(a) gives the encoding for a sample rule. This simple scheme slashes the space requirements for a synopsis. A variable length encoding for symbols further improves space usage. Note that the ability to encode our structure in this way does not apply to other XML synopses, such as XS-KETCH, because in those structures each node can be pointed to by any other node, and thus a pointer-based representation is necessary.

The Dynamic Case. In the dynamic case, for small synopses it is easy to simply re-encode the entire synopsis from scratch. For larger synopses, we split the encoding into an array of blocks, leaving padding in each block. A standard ordered file maintenance algorithm, such as that of M. A. Bender et al [3] can then be used to speed up insertions and deletions (for an array of n elements, we can insert and delete elements maintaining the order of the array in O(log² n) time).

### Experiments

In this section we give an empirical evaluation of our system. Our experiments were implemented in C and C++. The BPLEX algorithm was used with maximal rank maximal size of a right-hand side 20, and window size 40000 (1000 in the case of updates).

For our data sets, we chose DBLP [11], XMark [21], SwissProt [2], and the Protein Sequence Database [25]. These data sets have intrinsically different structures, ranging from the simplest (DBLP) to the most complicated (XMark)—FIG. 13(b) gives the salient aspects of each data set. For our update experiments, we used the catalog data set, generated by the XBench data generator [27].

### Evaluation of Estimation Quality

In our first experiment we test the quality of our selectivity estimation technique using randomly generated queries. We restrict our queries to branching path queries, having between l and u nodes (we chose the values l=3 and u=5 for our experiments). To generate queries, we make use of the full F/B-index of the data set in question, which contains the exact answers for all branching path queries.

We generate each query as follows. First, we pick the number of nodes in the query by choosing an integer uniformly and at random in the range [l, u]. The match node of the query is selected at random over all nodes in the F/B index, with the probability of picking each node being its selectivity divided by |D|. Thus, high selectivity nodes are favoured. We then repeat the following process until we reach the desired number of nodes in the query: we pick an insertion point in the query at random, where the possible insertion points are at the root (i.e., inserting a new root node for the query), and at each node (i.e., inserting a new leaf node for the query). Once an insertion point is selected, we then randomly select a node from the relevant subset of the F/B index, biasing for high selectivity nodes.

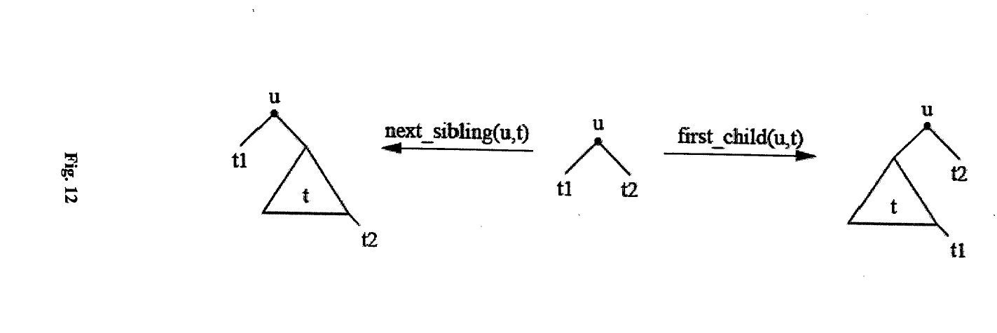

We iterate the above procedure to generate a query workload of 100 queries. We constructed synopses using different values of the threshold parameter; for some values the corresponding sizes of the synopsis is shown in the graphs of FIG. 14. For each synopsis, we compare the selectivity estimates for each query with the exact selectivity. Our graphs report the average relative error for both the lower and upper bound estimates.

As can be seen, as the threshold parameter decreases the lower and upper bounds both correspondingly decrease. It is also clear that the upper bounds are less accurate than the lower bounds. One reason for this is due to our query workload, which consisted of twigs which make use of the descendant-or-self axis. This axis is particularly badly affected by the presence of * nodes in the grammar, and hence the upper bounds tend to be higher. Nevertheless, the upper bounds are still well within a useful range, and the combination of an accurate lower bound and a slightly less accurate upper bound still give the query plan generator more information regarding the accuracy of the estimate than existing techniques.

### Handling Updates

In this experiment we investigate the effect of updates on the size of the synopsis. Our updates were performed randomly on the catalog XML data set, in the following fashion:

1. An initial 80,000 node subset of the XML document is chosen at random to be the “seed” document.

2. Until the entire document is reconstructed, we randomly choose to either delete a node from the constructed tree, or insert a new subtree from the original document. The set of subtrees considered for insertion consists of all subtrees rooted at nodes of depth two in the original document, that are not yet included in the constructed document.

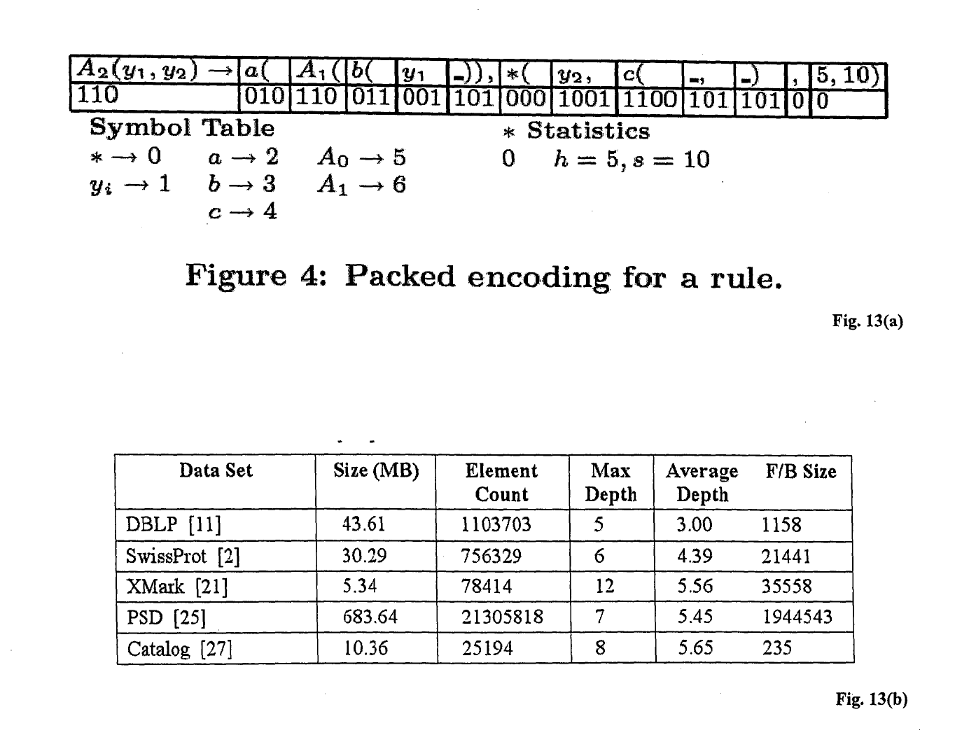

FIG. 15(b) gives the results for two different runs of this experiment: one where no deletions are performed (1700 updates), and one where 20% of the operations are deletions (2300 updates). The graphs plot the relative size of the incrementally updated synopsis against the size of the synopsis that would be obtained if we recomputed the synopsis from scratch at that point. As can be seen, the space overhead imposed by updates remains relatively constant at about 40% of additional space. The initial spike in space usage is due to the fact that inserting or deleting nodes from the synopsis results in an initial “unrolling” of the grammar; however, due to the fact that XML documents are actually quite structured, after this initial increase in size it appears that there is little need to perform further unrolling.

We also note that if the updated synopsis becomes too large, its size can be reduced by running BPLEX on the underlying database again. This behaviour can be seen in FIG. 15(c), where we periodically, after each 400 updates, decompress and run BPLEX on the database again. As can be seen, the amount of space saved in this way is small and constant. This strengthens our belief that all updates can always be done on the grammar and that recomputation from the underlying database is not necessary. Note that for small documents it can happen that an updated synopsis becomes even smaller than the corresponding base synopsis; a similar effect can be seen in FIG. 15(c) where the recomputed synopsis seems to become larger than the updated one towards the end. This is due to the bottom-up search order of BPLEX and suggests that a randomized version of BPLEX will outperform the current implementation.

### 5 Discussion and Comparison

Our results demonstrate that our system can indeed handle a wide range of queries in a small space budget, and furthermore that the synopsis can efficiently be updated. It is clear that the lower bounds are more accurate than the upper bounds in our work, although the relative difference is dependent on the types of queries. There is no related work which provides an equivalent set of features to our work.

Z. Chen et al. [6] reported errors of approximately 50% using a synopsis size of 1% for DBLP and 5% for SwissProt. In contrast, as FIGS. 14(a) and 14(b) show, we obtain an error rate of less than 2% for lower bounds, and 10% for upper bounds, using a synopsis size of 120 KB (0.27%) for DBLP, and an error rate of about 2% for lower bounds, and 5% for upper bounds, using a synopsis size of about 62 KB (0.24%) for SwissProt.

For XSketch, we found that with an XMark database of 5.4 MB, and a branching query workload without value predicates, they obtained 20-40% error rates using between 5 and 50 KB for the synopsis. As can be seen from FIG. 14(d), our results are comparable or better over this range (we used a similarly sized)(Mark database for comparison purposes). Note that with a synopsis size of about 32 KB we can compute exact selectivities and can handle updates without any disk accesses! Further, it is worth keeping in mind that our synopsis supports the full structural power of XPath.

It is difficult to determine the relative quality of StatiX and our work from the experimental results in their paper. It is clear that StatiX produces very accurate results, although as shown in our results with very small space it is possible to even produce exact results. Our work also handles a larger range of structural queries than StatiX, and is more amenable to updates. For example, the update strategy of IMAX occasionally requires a recomputation from the database, whereas our update strategy will never go back to the actual data.

We have introduced a new selectivity estimation technique for structural XML queries that boasts several advantages over existing synopsis structures. It supports all thirteen XPath axes, whilst also being amenable to efficient updates. Instead of returning educated guesses, as many other techniques do, we instead return a range within which the selectivity is guaranteed to lie. This is particularly useful for query optimizers, as it allows them to determine the relative confidence of two selectivity estimates. Our experimental results have demonstrated that our approach, despite its additional features, is competitive with existing techniques, in both accuracy and space. Our synopsis is a holographic representation of the XML document tree and might be useful for other applications besides selectivity estimation.

The invention can be used to handle XML data values as well as structural queries. A possible way of doing this is to keep separate from the tree structure a synopsis for data values which is built using conventional techniques. Then an efficient way to fetch at a leaf node of our synopsis the corresponding (estimation of the) data value. Another possibility of handling data values is to store them symbolically as part of the tree structure, and to apply our compression techniques directly on the tree. Consider, for instance, string values stored as monadic trees; for such trees our technique achieves high compression as it corresponds to Lempel-Ziv-like string compression. Unlike before, only lengths have to be stored when pruning, and, the string after a pruning can still be used in the selectivity estimation of the query.

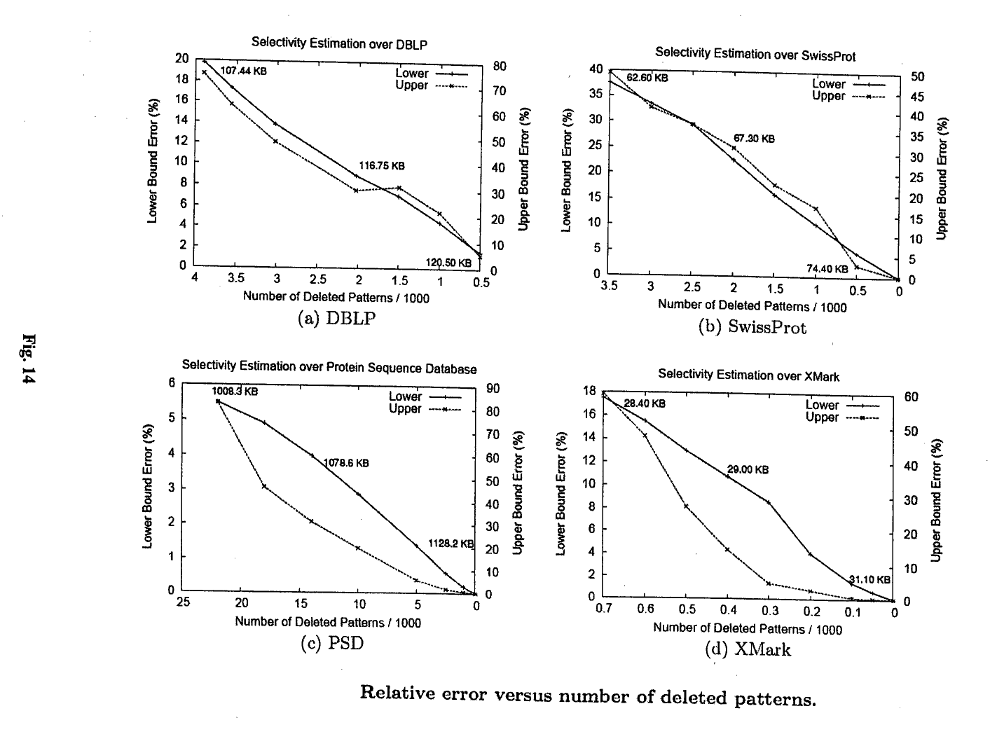

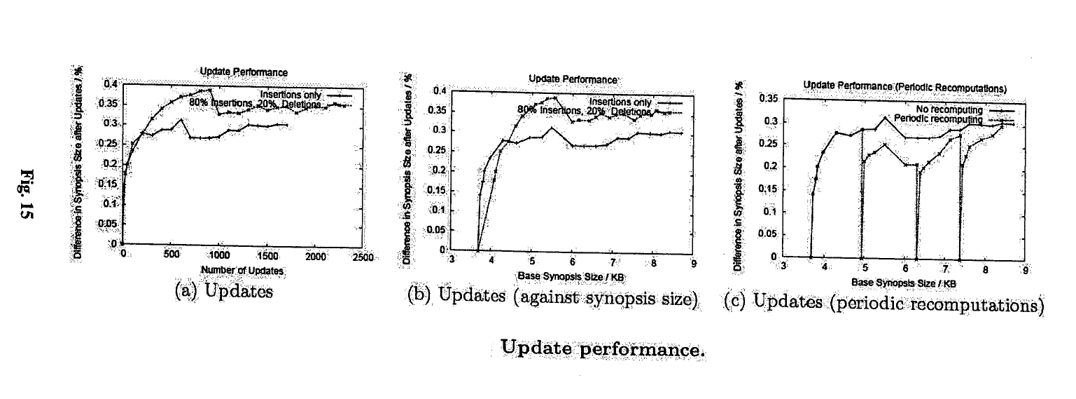

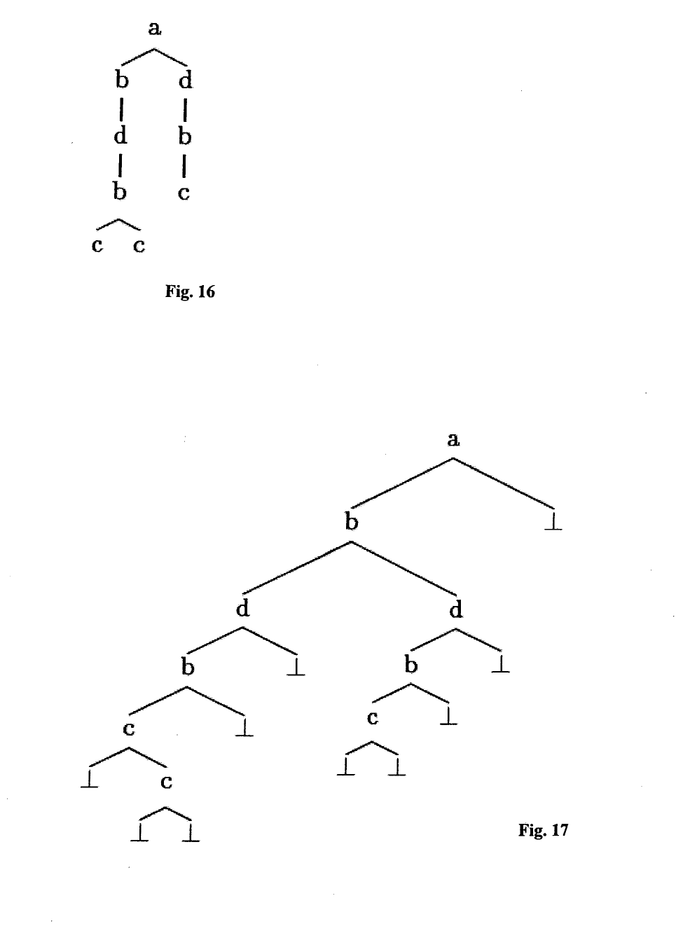

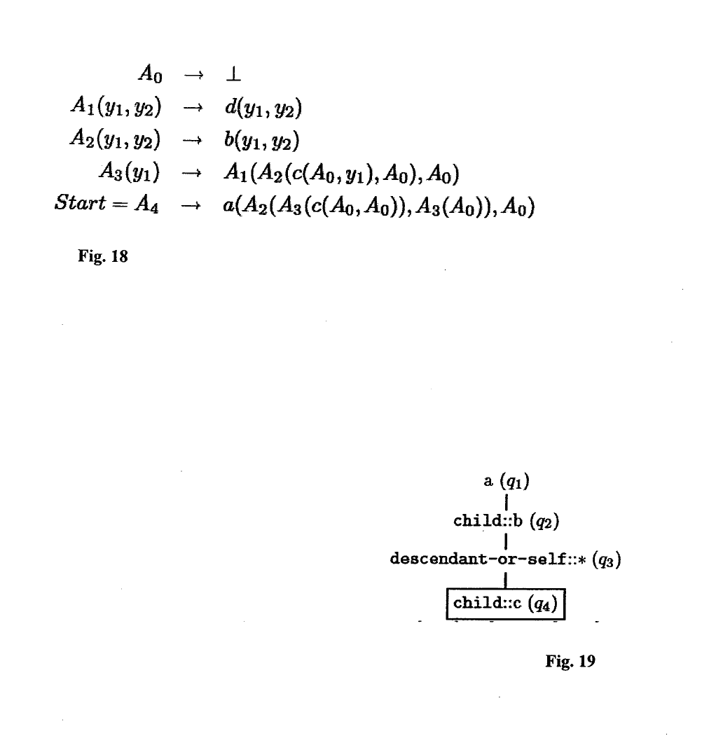

We now set out further detailed examples of the invention. Consider the XML document (D) tree of FIG. 16. The binary representation of this tree bin(D) is shown 20 in FIG. 17. This can be represented using the SLT grammar (G) of FIG. 18. Note that this grammar is not generated by the BPLEX algorithm, but is only used here for illustrative purposes.

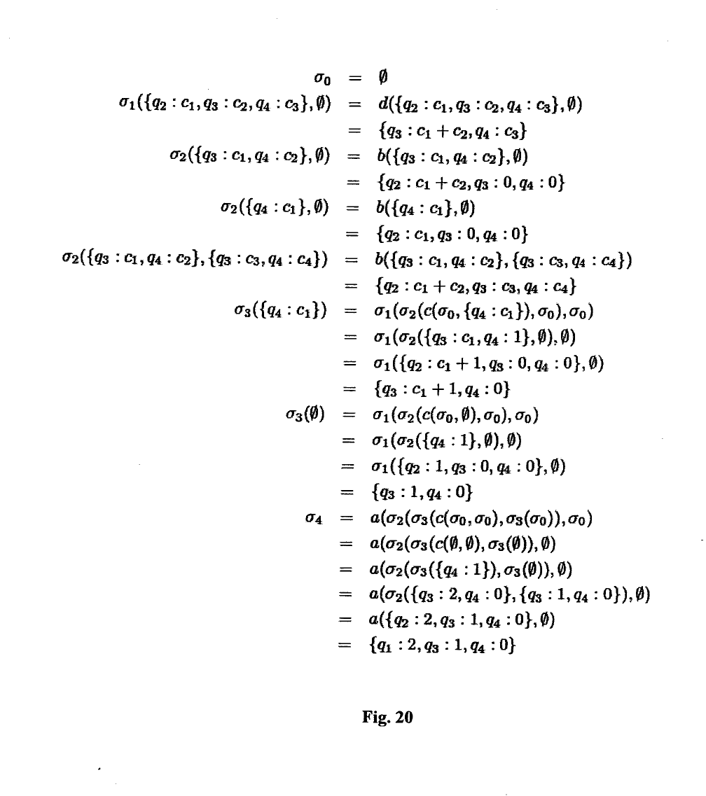

Consider the XPath query a/child::b/descendant-or-self*/child::c/, represented graphically as shown in FIG. 19. This query selects c-nodes that have a b-node as ancestor, such that the parent of the b-node is labelled a. Clearly, there are two c-nodes in the tree which satisfy the query. Hence, the exact selectivity of this query on our tree is two. It is shown in the description above how to construct a counting tree automaton for the above query. Running this automaton on the grammar representation results in the state function computations shown in FIG. 20 from which we can read the answer as 2.

Pruning the Synopsis, with Threshold=1

When the threshold=1 we delete (at most) one pattern. We start bottom-up (from A₁ to A₄) and look for the pattern that is used the least often. The corresponding definition will be deleted and the nonterminal on its left-hand side will be replaced by a star-symbol, in the remaining rules of the grammar.

In order to decide which pattern(s) appear the least often, we compute the multiplicity of the definitions: A₁ appears 2 times, A₂ appears 3 times, and A₃ appears 2 times. Going bottom-up this implies that A₁ will be deleted. Since the pattern in the right-hand side of A₁ has height and size equal to one, we replace A₁ (t₁,t₂) by the tree *(t₁,t₂,1,1). Note that the semantics of a star-symbol says that the last tree t in *(. . . , t,height,size) is, in the original unranked XML document, next to what was deleted; since the right-hand side of the A₁-rule is d(y₁,y₂), it means that the second argument tree t₂ in A₁(t₁,t₂) will be the next sibling of d in the unranked representation. This is the reason for replacing Aᵢ(t₁,t₂) by *(t₁,t₂,1,1). Below, when we compute the pruning for threshold=2 we will see an example where the last parameter tree of a nonterminal is not a next sibling. In such a case no argument tree will be a next sibling and therefore we will put the empty “_” as last argument of the star-symbol.

The resulting grammar is:
A₀→⊥
A₂ (y₁, y₂)→b(y₁,y₂)
A₃ (y₁)→(A₂(c(A₀,y₁),A₀),A₀,1,1)
Start=A₄→a(A₂(A₃(c(A₀,A₀)),A₃(A₀)),A₀)

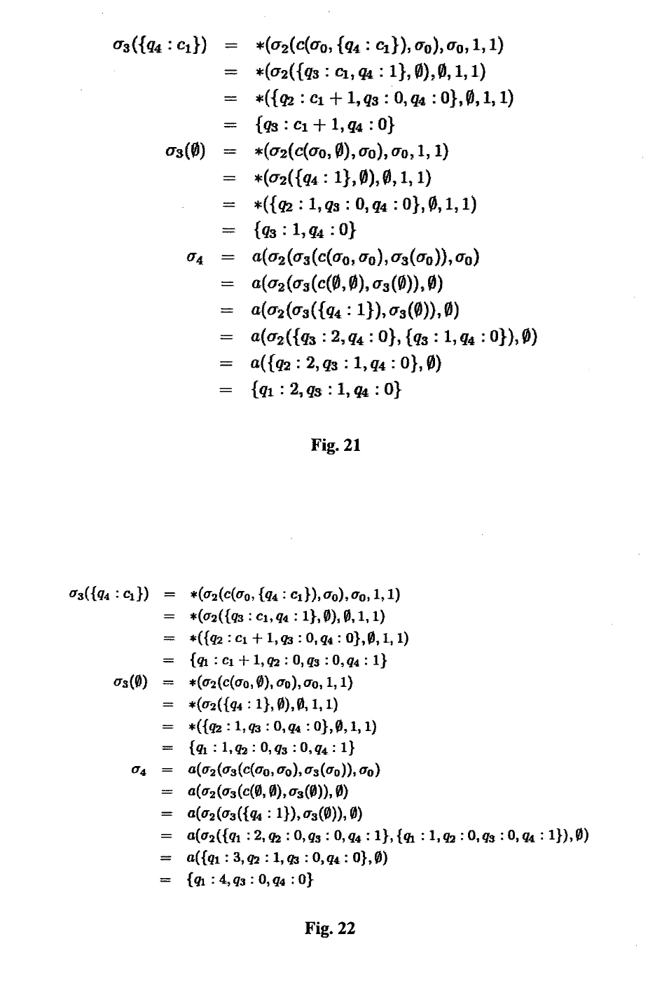

We now estimate lower and upper bounds for the selectivity of our query as follows. To compute the lower bound we simply ignore star-nodes. The computation for the lower bound computation as shown in FIG. 21 (since the definitions of σ₀ and σ₂ are unchanged, we omit them).

This yields an answer of 2 for the lower bound (coincidentally this is exactly the right answer).

For the upper bound, we consider all possible trees that are of size 1, at the star positions. In particular, the star-symbol generated by the first occurrence of A₃ in the right-hand side of the start rule could be a c-node, which means an additional match of the query. Similarly, the star-symbol generated by the second occurrence of A₃ in the right-hand side of the start-rule could be a b-node, which also implies an additional match of the query. Hence, the upper bound for this query is 4. The full computation is shown in FIG. 22.

Pruning the Synopsis, with Threshold=2

The next-least appearing pattern in our grammar is the one generated by A₃. Removing it, and replacing A₃ by a corresponding star-tree gives:
A₀→⊥
A₂ (y₁, y₂)→b(y₁, y₂)
Start=A₄→a(A₂(*(c(A₀,A₀),A₀,3,3), *(A₀,A₀,3,3)),A₀)

As discussed above, we now had to insert an extra empty tree (=A₀) as last argument of the star-symbol because the parameter y₁ of A₃ is not the right-most leaf of (the expansion of) the right-hand side A₁(A₂((c(A₀,y₁),A₀),A₀). Hence any parameter tree to A₃ will be below the part that is deleted, and not next to it.

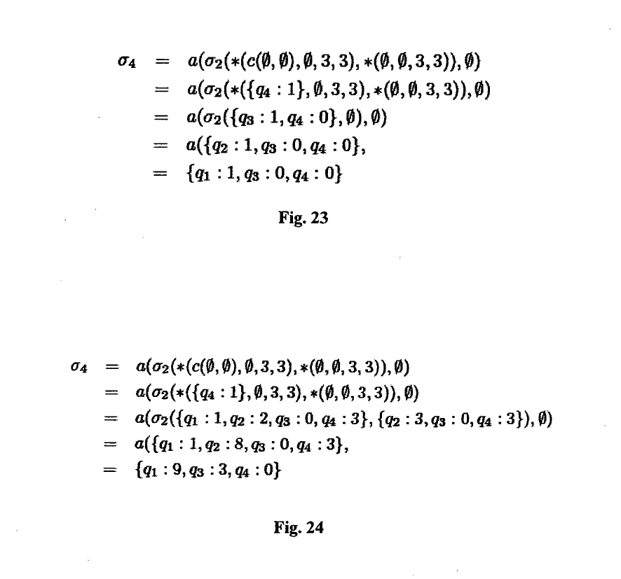

Now only one c-node remains that matches the query. Hence, the lower bound selectivity estimation is 1. The computation is shown in FIG. 23. The upper bound computation is shown in FIG. 24.

### Updates

Note that “1.2.1.1” in Dewey notation refers to the “address” of the c-node, i.e., from the root node you walk left/right/left/left(=1.2.1.1) to get to the c-node.

The update is realised by applying rules to the right-hand side of the start-rule, until the node to be updated has no further nonterminals on its path to the root. In our example this means that we first have to apply the A₂-rule, and then the A₃-rule to the right-most A₃ in the right-hand side of the start-rule. We get:
a(A₂(A₃(c(A₀,A₀)),A₃(A₀)),A₀)
   [symbol] a(b(A₃(c(A₀,A₀)),A₃(A₀)),A₀)
   [symbol] a(A₂(A₃(c(A₀,A₀)),A₁(c(A₀,A₀),A₀),A₀)),A₀)

Now we apply the A₁-rule and obtain:
a(A₂(A₃(c(A₀,A₀)),d(A₂(c(A₀,A₀),A₀),A₀)),A₀)

Finally we apply the A₂ rule and get:
a(A₂(A₃(c(A₀,A₀)),d(b(c(A₀,A₀),A₀),A₀)),A₀)

In this tree the path from the root node to the desired c-node has no nonterminals. Hence, we are ready to do the update. Insertion of the tree g(_,_) gives:
a(A₂(A₃(c(A₀,A₀)) ,d(b(c(A₀g(A₀,A₀),A₀),A₀)),A₀)

Note that all occurrences of empty trees are always represented by the special nonterminal A₀. Next, we now compress the new start-rule right-hand side again, using the existing rules. Since all previous patterns are still present we simply obtain:
a(A₂(A₃(c(A₀,A₀)),A₃(g(A₀,A₀))),A₀)

Hence, the final grammar after update is:
A₀→⊥
A₁ (y₁, y₂)→d(y₁, y₂)
A₂ (y₁, y₂)→b(y₁, y₂)
A₃ (y₁)→A₁(A₂(c(A₀,y₁),A₀),A₀)
Start=A₄→a(A₂(A₃(c(A₀,A₀)),A₃(g(A₀,A₀))),A₀)

### Update to a Pruned Position

Consider the update next_sibling 1.2.1.1 g(_,_) discussed above, but now we want to apply it to a pruned grammar, say, the one we obtained for threshold=2. Since at position 1.2 there is a star, we must go back through the original grammar to restore this part of the tree. For example, the lossless version of the grammar that is stored on disk rather than in memory. After the update we have:
a(A₂*(c(A₀,A₀),_{—},3,3),A₃(g(A₀,A₀))),A₀)

Since the nonterminal A₃ is not present in the pruned grammar, we replace it again by a star-node and obtain as final grammar:
A₀→⊥
A₂ (y₁, y₂)→b(y₁, y₂)
Start=A₄→a(A₂(*(c(A₀,A₀),_{—},3,3), *(g(A₀,A₀),_{—},3,3))

It will be appreciated by persons skilled in the art that numerous variations and/or modifications may be made to the invention as shown in the specific embodiments without departing from the spirit or scope of the invention as broadly described.

The embodiments here convert the tree structured data to a ranked tree first, however this step is not essential. The BPLEX algorithm which is used to get the initial compressed set of definitions can easily be changed to produce an unranked tree representation. The invention can be performed on an unranked tree representation simply by using automata (with and without) counting which operate on unranked trees.

For example, selectivity estimators can be used to provide feedback during query construction. For instance, they can be incorporated into a graphical tool which assist the user in determining whether the query will be too expensive to run on their database. Also selectivity estimation can be used to estimate the time it will take to execute a query.

We can extend our results to certain types of graphs (ones that can be represented by a straight line grammar). A grammar is simply a way of representing a set of strings. For instance, the grammar:
A→a A b
A→ab
   represents the set of all strings made up of an equal number of a's and b's, with the a's occurring before the b's. One can test whether a string lies in the grammar by attempting to construct a parse tree of the string. For instance, for the string aaabbb we get:
aaabbb→a(aaabbb)b
   →a(a(aabb)b)b
   →a(a(a(ab)b)b
   →a(a(a(A)b)b
   →a(a(A)b)b
   →a(A)b
   →A

A straight line grammar is simply a grammar which represents at most one string and the invention can be applied to these types of grammars.

The invention can be used with conventional context free grammars. Unlike the grammar used to provide an embodiment of the invention here, conventional context-free tree grammars can be used. Variables of a definition can be appear an arbitrary amount of times rather than just once in a definition.

The way to extend the application of the invention to graphs is to replace the tokens in the grammar (currently simple nodes like “a”, “b”, and “c”) with graphs. Then, when you run through the grammar, instead of constructing a string (or a tree), you end up with a graph.

The present embodiments are, therefore, to be considered in all respects as illustrative and not restrictive.

### REFERENCES

[2] A. Bairoch et al. The universal protein resource (UniProt). Nucleic Acids, 33:154-159, 2005.
[3] M. A. Bender et al. Two simplified algorithms for maintaining order in a list. In ESA, pages 152-164, 2002.
[5] G. Busatto, M. Lohrey, and S. Maneth. Efficient memory representation of XML documents. In DBPL, pages 199-216, 2005.
[6] Z. Chen et al. Counting twig matches in a tree. In ICDE, pages 595-604, 2001.
[7] J. Clark and S. DeRose. XML path language (XPath) version 1.0. http://www.w3.org/TR/xpath.
[9] G. Gottlob, C. Koch, and R. Pichler. Efficient algorithms for processing XPath queries. ACM ToDS, 30(2):444-491, 2005.
[11] M. Ley. Digital bibliography and library project. http://dblp.uni-trier.de/.
[13] M. Lohrey and S. Maneth. Tree automata and XPath on compressed trees. In CIAA, pages 225-237, 2005.
[21] A. Schmidt et al. XMark: A benchmark for XML data management. In VLDB, pages 974-985, 2002.
[22] H. Seidl. Finite tree automata with cost functions. TCS, 126:113-142, 1994.
[25] C. H. Wu et al. The protein information resource. Nucleic Acids Research, 31:345-347, 2003.
[27] B. Bin Yao, M. Tamer “Ozsu, and N. Khandelwal. XBench benchmark and performance testing of XML DBMSs. In ICDE, pages 621-633, 2004.

1. A method of generating a compressed representation of tree structured data, the method comprising the steps of:
(a) compressing the tree structured data by converting the tree structured data to a set of definitions that can each refer to other definitions of the set and/or a terminal definition that does not refer to any definition;
(b) determining the number of times each definition is referenced in other definitions; and
(c) compressing the set of definitions by deleting the definition that is referred to in other definitions substantially the least, and replacing all references to the deleted definition with an indication that the definition has been deleted.

2. A method according to claim 1, wherein the method further comprises the step of.
(d) repeating step (c) until the set of definitions is sufficiently compressed.

3. A method according to claim 2, wherein the set of definition is sufficiently compressed when a predetermined number of definitions have been deleted, the set of definitions is a predetermined size or each of the definitions in the set do not refer to any other definition.

4. A method according to claim 1, wherein the method further comprises the step of using the compressed representation of the tree structured data for determining the selectivity of a query to be performed on the tree structured data, for determining an execution plan for the query on the tree structured data, or for approximate query answering.

5. A method according to claim 1, wherein step (c) includes identifying repetitions of subtrees and/or tree patterns consisting of at least two nodes and replacing them with a reference to a definition and creating a new definition defining the identified subtree and/or tree pattern.

6. (canceled)

7. A method according to claim 1, wherein the indication that the definition has been deleted comprises statistical information of the deleted definition.

8. A method according to claim 7, wherein the statistical information includes the size and height values of the subtree and/or tree pattern that the deleted definition defines.

9. A method according to claim 7, wherein the method further comprises creating a lookup table for all statistical information of definitions that have been deleted and associating the indications in the compressed representation with a look-up value from the look-up table corresponding to the statistical information of the respective indication.

10. (canceled)

11. A method according to claim 1, wherein the method further comprises the initial step of converting the tree structured data to a ranked tree, and step (a) is performed on the ranked tree.

12. (canceled)

13. Software to operate a computer system to perform the method of claim 1.

14. A computer system for generating a compressed representation of tree structured data comprising:
a first storage means to store tree structured data;
a second storage means to store the compressed representation of tree structured data;
a processor to operate to access the tree structured data on the first storage means;
to compress the tree structured data by converting the tree structured data to a set of definitions that can each refer to other definitions of the set and/or a terminal definition that does not refer to any definition, to determine the number of times each definition is referenced in other definitions, to compress the set of definitions by deleting the definition that is referred to in other definitions substantially the least, and replacing all references to the deleted definition with an indication that the definition has been deleted; and to cause the set of definitions to be stored on the second storage means.

15-16. (canceled)

17. A method for determining a selectivity of a query over tree structured data, the method being performed on a compressed form of the tree structured data that is comprised of a set of definitions each defining part of the tree structured data, and where appropriate a definition refers to one or more definitions in the set of definitions, and the set of definitions includes a start definition that defines the tree structured data starting from a root node of the tree structured data, the method comprising the step of (a) converting the query into an equivalent automaton by decomposing the query into subqueries, each subquery having an associated counter;
(b) running the automaton against the compressed form of the tree structured data starting from the start definition to determine whether any subqueries match the start definition and for each match of a subquery incrementing the counter of the subquery and determining whether any of the subqueries match any of the definitions referenced in the start definition and for each match of a subquery to a referenced definition incrementing the counter of the subquery, wherein the start definition inherits counter values of subqueries matched on definitions it references; and
(c) determining the selectivity of the query based on the counters of each subquery.

18. A method according to claim 17, wherein a definition comprises input parameters.

19. A method according to claim 18, wherein a definition referenced by the start definition comprises input parameters.

20. A method according to claim 19, wherein the step of determining whether any of the subqueries match any of the definitions referenced in the start definition includes passing to the definition referenced by the start definition input parameters determined in the start definition.

21. A method according to claim 18, wherein the input parameters indicate whether a subquery has or has not got a match in the start definition.

22. A method according claim 18, wherein the input parameters includes the associated counter of a subquery.

23. A method according to claim 22, wherein a definition referenced by the start definition comprises input parameters, and the step of determining whether a subquery matches this referenced definition comprises only determining whether there is match based on parameters passed from the start definition.

24. A method according to claim 19, wherein a definition referenced by the start definition also references a third definition, and the definition referenced by the start definition inherits counter values from and passes parameters to the third definition.

25. A method according to claim 17, wherein the step of determining whether any of the subqueries match any of the definitions referenced in the start definition is performed recursively.

26. A method according to claim 17, wherein a definition from the set of definitions includes an indication that a further definition referenced by the definition has been deleted, and the determined selectivity of the query is an estimate.

27. A method according to claim 26, wherein the method further comprises estimating a lower bound selectivity of the query on the tree structured data by determining whether any of the subqueries match a definition which includes an indication that a further definition has been deleted, and assuming that there are no matches for the further definition and not incrementing the counter for the subquery.

28. A method according to claim 26, wherein the method further comprises estimating an upper bound selectivity of the query on the tree structured data by determining whether any of the subqueries match a definition that includes an indication that a further definition has been deleted, and assuming that the maximum number of matches would be found in the deleted definition and incrementing the counter accordingly.

29. A method according to claim 28, wherein the indication that a further definition referenced by the definition has been deleted includes statistical information on the deleted definition, and the step of assuming the maximum number is determined from the statistical information of the deleted definition.

30. A method according to claim 29, wherein the statistical information includes the size and/or height of the tree structured data that the deleted definition defines.

31. A method according to claim 17, wherein the method is performed on a stored compressed representation of the tree structured data and comprises the steps of decoding the first definition, the end of which defines the start of the next definition.

32-33. (canceled)

34. Software to operate a computer system to perform the method of claim 17.

35. A computer system for determining selectivity of a query over tree structured data, the computer system comprising:
storage means to store a compressed form of the tree structured data that is comprised of a set of definitions each defining part of the tree structured data, and where appropriate a definition refers to one or more definitions in the set of definitions, and the set of definitions includes a start definition that defines the tree structured data starting from a root node of the tree structured data;
input means to receive the query;
processor that operates to convert the query into an equivalent automaton by decomposing the query into subqueries, each subquery having an associated counter; to run the automaton against the compressed form of the tree structured data starting from the start definition to determine whether any subqueries match the start definition and for each match of a subquery incrementing the counter of the subquery; and to determine whether any of the subqueries match any of the definitions referenced in the start definition and for each match of a subquery incrementing the counter of the subquery; wherein the start definition inherits counter values of subqueries matched on definitions it references; and to determine the selectivity of the query based on the counters of the subqueries.

36-37. (canceled)

38. A method for updating a compressed representation of tree structured data, wherein the update is performed on a node of the tree structured data and the compressed representation is comprised of a set of definitions including a start definition that defines the tree structured data starting at a root of the tree and includes references to one or more antecedent definitions in the set of definitions, and at least one antecedent definition is a terminal definition that does not refer to any definition, the method comprising the steps of:
(a) if the start definition includes a reference to an antecedent definition on a path from the root to the node to be updated, replacing the reference to the antecedent definition with a definition;
(b) repeating (a) until there is no reference to an antecedent definition on the path from the root to the node to be updated other than references to antecedent terminal definitions; and
(c) performing the update on the node.

39. A method according to claim 38, further comprising the step of re-compressing the set of definitions.

40. A method according to claim 39, wherein the step of re-compressing the set of definitions comprises identifying repetitions of subtrees and/or tree patterns consisting of at least two nodes and replacing them with a reference to a definition that describes the identified subtree or tree pattern.

41. A method according to claim 40, wherein the step of re-compressing the set of definitions further comprises determining the number of times each definition is referenced in other definitions; and compressing the set of definitions by deleting the definition that is referred to in other definitions substantially the least, and replacing all references to the deleted definition with an indication that the definition has been deleted.

42-43. (canceled)

44. A method according to claim 38, wherein the update to the node is inserting a first child to the node, inserting a sibling to the node or deleting the node and its dependent nodes.

45. A method according to claim 38, wherein the method further comprises identifying the node to be updated using the Dewey notation system.

46. A method according to claim 38, wherein the path from the root to the node to be updated includes an indication that part of a definition has been deleted; and the method further comprises replacing the indication that the definition of the node has been deleted with the definition.

47. (canceled)

48. Software to operate a computer system to perform the method of claim 39.

49. A computer system for updating a compressed representation of tree structured data, wherein the update is performed on a node of the tree structured data and the compressed representation is comprised of a set of definitions including a start definition that defines the tree structured data starting at a root of the tree and includes references to one or more antecedent definitions in the set of definitions, and at least one antecedent definition that is a terminal definition that does not refer to any definition, the computer system comprising:
a storage means to store the compressed representation of the tree structured data; and
a processor to perform the update on the node, wherein if the start definition includes a reference to an antecedent definition on a path from the root to the node to be updated, the processor operates to replace the reference to the antecedent definition with a definition; and
to repeat this until there is no reference to an antecedent definition on the path from the root to the node to be updated other than references to antecedent terminal definitions.

51. (canceled)
